(19) United States
(12) Patent Application Publication
(10) Pub. No.: US 2022/0016980 A1
(43) Pub. Date: Jan. 20, 2022

(54) DISPLAY CONTROL DEVICE AND NON-TRANSITORY COMPUTER-READABLE STORAGE MEDIUM FOR DISPLAY CONTROL ON HEAD-UP DISPLAY

(71) Applicant: DENSO CORPORATION, Kariya-city (JP)

(72) Inventors: Daisuke TAKEMORI, Kariya-city (JP); Akihiko YAGYU, Kariya-city (JP); Yasuhiro SHIMIZU, Kariya-city (JP); Kazuki KOJIMA, Kariya-city (JP); Shiori MANEYAMA, Kariya-city (JP)

(21) Appl. No.: 17/488,950

(22) Filed: Sep. 29, 2021

Related U.S. Application Data
(63) Continuation of application No. PCT/JP2020/009938, filed on Mar. 9, 2020.

(30) Foreign Application Priority Data
Apr. 1, 2019 (JP) 2019-069984
Feb. 6, 2020 (JP) 2020-018977

(51) Int. Cl. B60K 35/00

(52) U.S. Cl. CPC B60K 35/00; B60K 2370/1529; B60Y 2300/18166; B60K 2370/1868; B60K 2370/52

(57) ABSTRACT

In a display control device for a head-up display of a vehicle, a schedule notification content indicating a fulfillment schedule of a lane change is displayed on a road surface in a foreground in a superimposing manner. When the schedule notification content overreaches an angle of view, a non-superimposition content indicating the fulfillment schedule of the lane change independent of a superimposition target may be displayed, or the schedule notification content may be hidden. In a case where an arrow-shaped schedule notification content, having a tip portion indicating an adjacent lane as a destination of the lane change, is displayed in a superimposing manner on a road surface in the foreground, when the tip portion of the schedule notification content in a reference shape overreaches the angle of view, the schedule notification content may be transformed so that the tip portion is positioned within the angle of view.

### CROSS REFERENCE TO RELATED APPLICATIONS

The present application is a continuation application of International Patent Application No. PCT/JP2020/009938 filed on Mar. 9, 2020, which designated the U.S. and claims the benefit of priority from Japanese Patent Application No. 2019-069984 filed on Apr. 1, 2019 and Japanese Patent Application No. 2020-018977 filed on Feb. 6, 2020. The entire disclosures of all of the above applications are incorporated herein by reference.

### TECHNICAL FIELD

The present disclosure relates to a display control device to control display on a head-up display and a non-transitory computer-readable storage medium to control display on a head-up display.

### BACKGROUND

For example, there is known a travel control apparatus that automatically generates a track of changing lanes and automatically guides a subject vehicle to the destination of the changed lane according to the generated track. The travel control apparatus superimposes a guidance display indicating positions to start or stop changing lanes based on the automatic guidance on a real image generated from a view captured in front of the subject vehicle and displays the image on display instruments such as a meter and a navigation system.

### SUMMARY

The present disclosure describes a display control device and a non-transitory computer-readable storage medium storing instructions for display control on a head-up display of a vehicle, which are capable of presenting a lane change fulfillment schedule in an easy-to-understand manner despite possible limitations on the angle of view of the head-up display.

As an example, a schedule notification content, indicating a fulfillment schedule of a lane change made by a lane change control unit of a vehicle, is displayed on a road surface in a foreground in a superimposing manner based on a lane change information acquired from a lane change control unit. When the schedule notification content overreaches an angle of view of the head-up display, a non-superimposition content that indicates a fulfillment schedule of the lane change independent of a superimposition target is displayed.

As another example, a schedule notification content using a road surface in a foreground as a superimposition target and a non-superimposition content indicating a fulfillment schedule of the lane change independent of the superimposition target are displayed as the content indicating the fulfillment schedule of the lane change. When the schedule notification content overreaches an angle of view of the head-up display, the schedule notification content is hidden.

As further another example, an arrow-shaped schedule notification content, having a tip portion indicating an adjacent lane as a destination of the lane change, is displayed in a superimposing manner on a road surface in a foreground based on a lane change information acquired from a lane change control unit. When the tip portion of the schedule notification content in the reference shape overreaches an angle of view of the head-up display, the schedule notification content is transformed so that the tip portion is positioned within the angle of view.

### BRIEF DESCRIPTION OF DRAWINGS

Features and advantages of the present disclosure will become more apparent from the following detailed description made with reference to the accompanying drawings, in which:

FIG. 1 is a diagram illustrating an overview of an in-vehicle network including HCU according to a first embodiment of the present disclosure;

FIG. 2 is a diagram illustrating a head-up display mounted on a vehicle;

FIG. 3 is a diagram illustrating a schematic configuration of HCU;

FIG. 4 is a diagram visually illustrating simulation of a display layout provided by a display generation unit;

FIG. 5 is a diagram illustrating a display of pattern 0 containing a response notification content;

FIG. 6 is a diagram illustrating a display of pattern 1 containing a fulfillment notification content;

FIG. 7 is a diagram illustrating a display of pattern 2 containing a partially discontinuous fulfillment notification content;

FIG. 8 is a diagram illustrating a display of pattern 3 containing a fulfillment notification icon;

FIG. 9 is a diagram illustrating a display of pattern 4 containing a standby notification content;

FIG. 10 is a diagram illustrating a display of pattern 5 containing a standby notification content and a different vehicle notification icon;

FIG. 11 is a diagram illustrating a display of pattern 6 containing a time-out notification icon;

FIG. 12 is a diagram illustrating a display of pattern 7 containing a fulfillment notification content;

FIG. 13 is a diagram illustrating another display of pattern 7 containing a fulfillment notification content;

FIG. 14 is a flowchart illustrating in detail a process to fulfill the display control method according to the first embodiment along with FIGS. 15 and 16;

FIG. 15 is a flowchart illustrating in detail a display control process along with FIGS. 14 and 16;

FIG. 16 is a flowchart illustrating in detail the display control process along with FIGS. 14 and 15;

FIG. 17 is a diagram illustrating comparison between display transition in an activated standby state and display transition in an inactivated standby state;

FIG. 18 is a flowchart illustrating in detail the display control process according to a second embodiment along with FIGS. 14 and 19;

FIG. 19 is a flowchart illustrating in detail the display control process along with FIGS. 14 and 18;

FIG. 20 is a diagram illustrating a display of pattern 0 according to the second embodiment;

FIG. 21 is a diagram illustrating a display of pattern 3 according to the second embodiment;

FIG. 22 is a diagram illustrating a display of pattern 4 according to the second embodiment;

FIG. 23 is a diagram illustrating a display of pattern 5 according to the second embodiment;

FIG. 24 is a flowchart illustrating in detail the display control process according to a third embodiment along with FIGS. 14 and 25;

FIG. 25 is a flowchart illustrating in detail the display control process along with FIGS. 14 and 24;

FIG. 26 is a diagram illustrating a display of pattern 1 according to the third embodiment;

FIG. 27 is a diagram illustrating a display of pattern 3 according to the third embodiment;

FIG. 28 is a diagram illustrating a display of pattern 4 according to the third embodiment;

FIG. 29 is a diagram illustrating a display of pattern 5 according to the third embodiment;

FIG. 30 is a flowchart illustrating in detail the display control process according to a fourth embodiment along with FIGS. 14 and 31;

FIG. 31 is a flowchart illustrating in detail the display control process along with FIGS. 14 and 30;

FIG. 32 is a diagram illustrating a display of pattern 1 according to the fourth embodiment;

FIG. 33 is a diagram illustrating a display of pattern 4 according to the fourth embodiment;

FIG. 34 is a diagram illustrating a display of pattern 5 according to the fourth embodiment;

FIG. 35 is a diagram illustrating a display image of a fulfillment notification content according to a fifth embodiment;

FIG. 36 is a diagram illustrating a display of pattern 0 according to the fifth embodiment;

FIG. 37 is a diagram illustrating a display of pattern 1 according to the fifth embodiment;

FIG. 38 is a diagram illustrating a display of pattern 1 when a lane change starts immediately;

FIG. 39 is a diagram illustrating a display of pattern 4 according to the fifth embodiment;

FIG. 40 is a diagram illustrating a display of pattern 5 according to the fifth embodiment;

FIG. 41 is a diagram illustrating a display of pattern 1 according to a first modification;

FIG. 42 is a diagram illustrating a display of pattern 1 according to a second modification;

FIG. 43 is a diagram illustrating a display of pattern 3 according to a sixth modification;

FIG. 44 is a flowchart illustrating in detail the display control process according to ninth and tenth modifications along with FIGS. 14 and 16;

FIG. 45 is a diagram illustrating a display of pattern 8 according to the ninth modification;

FIG. 46 is a diagram illustrating a display of pattern 8 according to the tenth modification;

FIG. 47 is a diagram illustrating a display of pattern 1 according to an eleventh modification;

FIG. 48 is a diagram illustrating a display of pattern 1 while a lane change is in process;

FIG. 49 is a diagram illustrating a display of pattern 1 according to a twelfth modification;

FIG. 50 is a diagram illustrating a display of pattern 1 while a lane change is in process; and

FIG. 51 is a diagram illustrating another display of pattern 1 while a lane change is in process.

### DETAILED DESCRIPTION

In a travel control apparatus that superimposes a guidance display indicating a position to start or stop changing lanes based on an automatic guidance on a real image generated from a view captured in front of the subject vehicle and displays the image on a display instrument, it is conceivable to use a head-up display as the display instrument. However, the head-up display has a limited angle of view. Therefore, if screen displays for a meter or a navigation system are simply used for the head-up display, the guidance display for a lane change based on the automatic guidance can easily overreach the angle of view of the head-up display. As a result, it could be supposed to be difficult to continuously provide lane change fulfillment schedules based on the automatic guidance.

The present disclosure provides a display control device and a non-transitory computer-readable storage medium storing instructions, which are capable of presenting a lane change fulfillment schedule in an easy-to-understand manner despite possible limitations on the angle of view of a head-up display.

According to a first aspect of the present disclosure, a display control device is used on a vehicle and controls a head-up display to display contents in a superimposing manner. The display control device includes an information acquisition unit and a display control unit. The information acquisition unit acquires lane change information about a relevant lane change from a lane change control unit that controls the lane change of the vehicle. The display control unit displays a schedule notification content, indicating a fulfillment schedule of the lane change made by the lane change control unit, to be superimposed on a road surface in a foreground based on the lane change information. When the schedule notification content overreaches an angle of view of the head-up display, the display control unit displays a non-superimposition content that indicates a fulfillment schedule of the lane change independent of a specified superimposition target.

According to a second aspect of the present disclosure, a display control program is used for a vehicle, controls a head-up display to display contents in a superimposing manner, and causes one or more processors to perform a process including: acquiring lane change information about a lane change from a lane change control unit that controls the lane change of the vehicle; displaying a schedule notification content, indicating a fulfillment schedule of the lane change made by the lane change control unit, to be superimposed on a road surface in a foreground based on the lane change information; and displaying a non-superimposition content that indicates a fulfillment schedule of the lane change independent of a specified superimposition target, when the schedule notification content overreaches an angle of view of the head-up display.

According to a third aspect of the present disclosure, a non-transitory computer-readable storage medium stores program instructions for controlling a head-up display of a vehicle to display a content in a superimposing manner. The program instructions cause one or more processors to: acquire lane change information about a lane change from a lane change control unit that controls the lane change of the vehicle; display a schedule notification content, indicating a fulfillment schedule of the lane change made by the lane change control unit, to be superimposed on a road surface in a foreground based on the lane change information; and displays a non-superimposition content that indicates a fulfillment schedule of the lane change independent of a specified superimposition target, when the schedule notification content overreaches an angle of view of the head-up display.

These aspects display the non-superimposition content indicating the lane change fulfillment schedule when the schedule notification content overreaches the angle of view of the head-up display. The non-superimposition content is independent of the superimposition target. Therefore, no overreach occurs practically due to the travel environment of vehicles. It is possible to provide the lane change fulfillment schedule in an easy-to-understand manner despite possible limitations on the angle of view of the head-up display.

According to a fourth aspect of the present disclosure, a display control device is used on a vehicle and controls a head-up display to display contents in a superimposing manner. The display control device includes an information acquisition unit and a display control unit. The information acquisition unit acquires lane change information about a lane change from a lane change control unit that controls the lane change of the vehicle. The display control unit displays a schedule notification content using a road surface in a foreground as a superimposition target and a non-superimposition content independent of the superimposition target, as the content indicating a fulfillment schedule of the lane change made by the lane change control unit. When the schedule notification content overreaches an angle of view of the head-up display, the display control unit hides the schedule notification content.

According to a fifth aspect of the present disclosure, a display control program is used for a vehicle, controls a head-up display to display contents in a superimposing manner, and causes one or more processors to perform a process including: acquiring lane change information about a lane change from a lane change control unit that controls the lane change of the vehicle; displaying a schedule notification content using a road surface in a foreground as a superimposition target and a non-superimposition content independent of the superimposition target, as the content indicating a fulfillment schedule of the lane change made by the lane change control unit; and hiding the schedule notification content when the schedule notification content overreaches an angle of view of the head-up display.

According to a sixth aspect of the present disclosure, a non-transitory computer-readable storage medium stores program instructions for controlling a head-up display of a vehicle to display a content in a superimposing manner. The program instructions cause one or more processors to: acquire lane change information about a lane change of the vehicle from a lane change control unit that controls the lane change of the vehicle; display a schedule notification content using a road surface in a foreground as a superimposition target and a non-superimposition content independent of the superimposition target, as the content indicating a fulfillment schedule of the lane change made by the lane change control unit; and hide the schedule notification content when the schedule notification content overreaches an angle of view of the head-up display.

These aspects display the contents indicating the fulfillment schedule of lane change made by the lane change control unit. The contents include not only a schedule notification content superimposed on the road surface, but also a non-superimposition content independent of the superimposition target. The non-superimposition content can continuously indicate the lane change fulfillment schedule without overreaching the angle of view. The schedule notification content is hidden when overreaching the angle of view, making it difficult to interfere with the visibility of the non-superimposition content. As above, it is possible to provide the lane change fulfillment schedule in an easy-to-understand manner despite possible limitations on the angle of view of the head-up display.

According to a seventh aspect of the present disclosure, a display control device is used on a vehicle and controls a head-up display to display contents in a superimposing manner. The display control device includes an information acquisition unit and a display control unit. The information acquisition unit acquires lane change information about a lane change of the vehicle from a lane change control unit that controls the lane change of the vehicle. The display control unit displays an arrow-shaped schedule notification content, having a tip portion indicating an adjacent lane as a destination of the lane change made by the lane change control unit, to be superimposed on a road surface in a foreground based on the lane change information. When the tip portion of the schedule notification content in the reference shape overreaches an angle of view of the head-up display, the display control unit transforms the schedule notification content so that the tip portion is positioned within the angle of view.

According to an eighth aspect of the present disclosure, a display control program is used for a vehicle, controls a head-up display to display contents in a superimposing manner, and causes one or more processors to perform a process including: acquiring lane change information about a lane change of the vehicle from a lane change control unit that controls the lane change of the vehicle; displaying an arrow-shaped schedule notification content, having a tip portion indicating an adjacent lane as a destination of the lane change made by the lane change control unit, in a superimposing manner by assuming a road surface in a foreground to be a superimposition target, based on the lane change information; and transforming the schedule notification content so that the tip portion of the schedule notification content in a reference shape is positioned within the angle of view when the tip portion overreaches an angle of view of the head-up display.

According to a ninth aspect of the present disclosure, a non-transitory computer-readable storage medium stores program instructions for controlling a head-up display of a vehicle to display a content in a superimposing manner. The program instructions cause one or more processors to: acquire lane change information about a lane change of the vehicle from a lane change control unit that controls the lane change of the vehicle; display an arrow-shaped schedule notification content, having a tip portion indicating an adjacent lane as a destination of the lane change made by the lane change control unit, in a superimposing manner by assuming a road surface in a foreground to be a superimposition target, based on the lane change information; and transforms the schedule notification content so that the tip portion of the schedule notification content in a reference shape is positioned within the angle of view when the tip portion overreaches an angle of view of the head-up display.

In these aspects, the tip portion of the schedule notification content as the reference shape may overreach the angle of view of the head-up display. Then, the schedule notification content is transformed so that the tip portion is positioned within the angle of view. The transformed schedule notification content can use the tip portion to continuously indicate the adjacent lane as a destination of the lane change. As above, it is possible to provide the lane change fulfillment schedule in an easy-to-understand manner despite possible limitations on the angle of view of the head-up display.

Embodiments of the present disclosure will be described by reference to the accompanying drawings. The same reference numerals may be used for the mutually corresponding elements in the embodiments to omit a duplicate description. A subsequent embodiment may describe only part of the configuration. In such a case, the other part of the configuration applies to the corresponding part of the configuration described in the preceding embodiment. Combinations of the configurations are not limited to those explicitly described in the embodiments. The configurations of the embodiments may be partially combined, even if not explicitly described, except for an invalid combination. The description below shall disclose an implicit combination of the embodiments and the configurations described in the modifications.

### First Embodiment

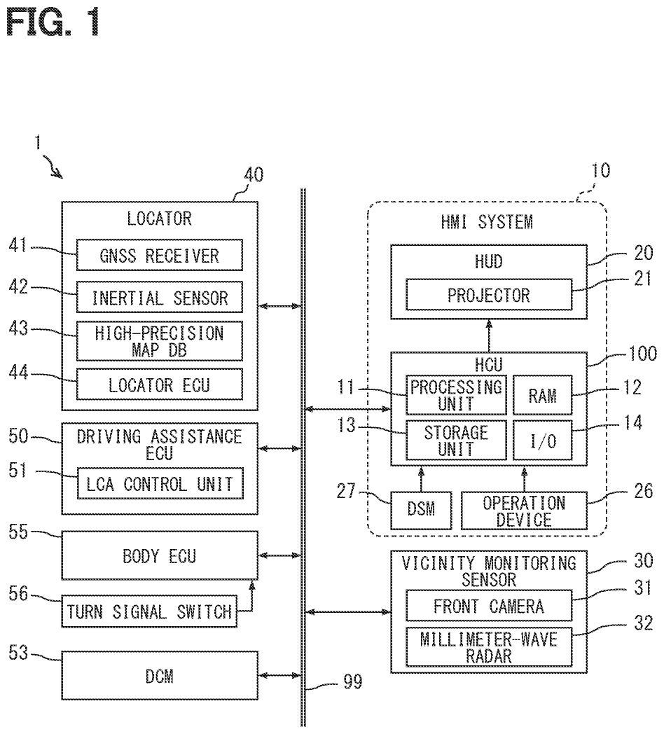

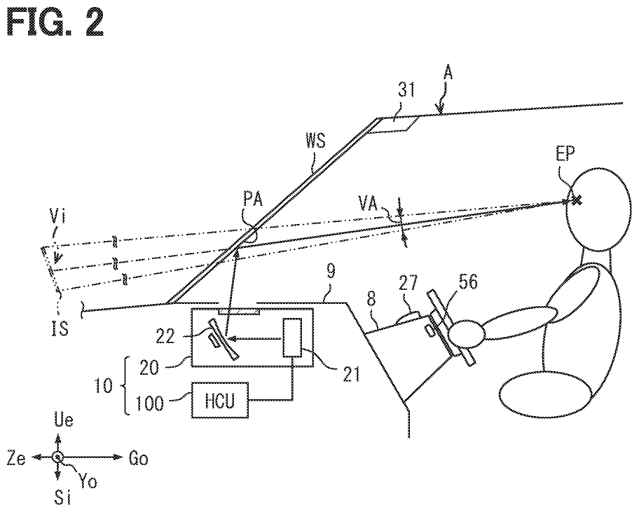

An HCU (Human Machine Interface Control Unit) 100 illustrated in FIGS. 1 and 2 provides functions of a display control device according to the first embodiment of the present disclosure. The HCU 100 configures an HMI (Human Machine Interface) system 10 used for vehicle A along with a head-up display (HUD) 20, for example. The HMI system 10 further includes an operation device 26 and a driver status monitor (DSM) 27, for example. The HMI system 10 includes an input interface function to accept user operations by an occupant (such as a driver) of vehicle A and an output interface function to provide the driver with information. The HMI system 10 is communicably connected to a communication bus 99 of an in-vehicle network 1 mounted on vehicle A. The HMI system 10 is one of the multiple nodes provided for the in-vehicle network 1. For example, the communication bus 99 of the in-vehicle network 1 connects with nodes such as a vicinity monitoring sensor 30, a locator 40, a driving assistance ECU (Electronic Control Unit) 50, DCM 53, and a body ECU 55. These nodes connected to communication bus 99 can communicate with each other. The specific nodes of these devices and ECUs may be directly electrically connected and may be capable of communication without the intermediation of the communication bus 99.

The following description defines a front-back direction (see Ze corresponding to forward and Go corresponding to backward in FIG. 2) and a horizontal direction (see Yo corresponding to sideways in FIG. 2) based on vehicle A motionlessly stationed on a level plane. Specifically, the front-back direction is defined in the longitudinal direction of vehicle A. The horizontal direction is defined in the width direction of vehicle A. A vertical direction (see Ue corresponding to upward and Si corresponding to downward in FIG. 2) is defined as the vertical direction against the level plane that defines the front-back direction and the horizontal direction. The symbols representing the directions may be omitted as appropriate for simplification.

The vicinity monitoring sensor 30 is an autonomous sensor that monitors the surrounding environment of vehicle A. The vicinity monitoring sensor 30 can detect moving objects and stationary objects from a detection range around the subject vehicle. The moving objects include pedestrians, cyclists, non-human animals, and other vehicles, for example. The stationary objects include falling objects on the road, guardrails, curbs, road signs, road markings such as road lane lines, and structures beside the road, for example. The vicinity monitoring sensor 30 uses the communication bus 99 to provide, for example, the driving assistance ECU 50 and the HCU 100 with detection information about objects detected around vehicle A.

The vicinity monitoring sensor 30 includes a front camera 31 and a millimeter-wave radar 32 as detection configurations for object detection. The front camera 31 outputs at least one of the imaging data acquired by capturing the front range of vehicle A and an analysis result of the imaging data as detection information. The multiple millimeter-wave radars 32 are placed, for example, on the front and rear bumpers of vehicle A at intervals. The millimeter-wave radar 32 irradiates millimeter waves or quasi-millimeter waves around vehicle A in the range corresponding to the front, front-side, rear, and rear-side. The millimeter-wave radar 32 generates detection information based on a process of receiving waves reflecting off moving objects and stationary objects, for example. It is desirable that the millimeter-wave radar 32 ensures at least 40 meters from vehicle A as the detection range on the right and left rear-sides. The vicinity monitoring sensor 30 may include the detection configurations such as a Lidar and a sonar.

The locator 40 generates, for example, highly accurate position information about vehicle A based on composite positioning that combines multiple pieces of acquired information. The locator 40 can identify a lane for vehicle A to travel among multiple lanes, for example. The locator 40 is configured to include a GNSS (Global Navigation Satellite System) receiver 41, an inertial sensor 42, a high-precision map database (high-precision map DB) 43, and a locator ECU 44.

The GNSS receiver 41 receives positioning signals transmitted from multiple artificial satellites (positioning satellites). The GNSS receiver 41 can receive positioning signals from positioning satellites of at least one of the satellite positioning systems such as GPS, GLONASS, Galileo, IRNSS, QZSS, and Beidou.

The inertial sensor 42 includes a gyro sensor and an acceleration sensor, for example. The high-precision map DB 43 is mainly composed of non-volatile memory and stores map data (high-precision map data) more accurate than that used for normal navigation. The high-precision map data maintains detailed information at least in the height (z) direction. The high-precision map data contains information available for automated driving and advanced driving assistance, such as three-dimensional shape information about roads, information about the number of lanes, and information indicating travel directions allowed for the lanes.

The locator ECU 44 mainly includes a microcomputer equipped with a processor, RAM, a storage unit, an input/output interface, and a bus connecting these. The locator ECU 44 combines positioning signals received by the GNSS receiver 41, measurement results from the inertial sensor 42, and the vehicle speed information output to the communication bus 99 and successively measures subject vehicle positions and traveling directions of vehicle A, for example. The locator ECU 44 uses the communication bus 99 to provide the driving assistance ECU 50 and the HCU 100, for example, with the position information and the direction information about vehicle A based on the positioning result.

The vehicle speed information represents the current traveling speed of vehicle A and is generated based on detection signals from a wheel speed sensor provided for the hub portion of each wheel of vehicle A. It is possible to change as needed the node (ECU) that generates the vehicle speed information and outputs it to the communication bus 99. For example, an in-vehicle ECU such as a brake control ECU to control the distribution of braking force to each wheel or the HCU 100 is electrically connected to the wheel speed sensor for each wheel and continuously generates the vehicle speed information and outputs it to the communication bus 99.

The locator ECU 44 determines whether the high-precision map DB 43 contains the required high-precision map data in response to a request from the HCU 100, for example. If the high-precision map DB 43 contains the required high-precision map data, the locator ECU 44 reads the corresponding high-precision map data from the high-precision map DB 43 and supplies it to the requesting HCU 100.

The driving assistance ECU 50 is mainly composed of a computer equipped with a processor, RAM, a storage unit, an input/output interface, and a bus connecting these. The driving assistance ECU 50 has at least a driving assistance function to assist the driver's driving operations or an automated driving function capable of acting for the driver's driving operations. The driving assistance ECU 50 recognizes the traveling environment around vehicle A based on the detection information acquired from the vicinity monitoring sensor 30.

The driving assistance ECU 50 can provide the HCU 100 with analyzed detection information, namely, the result of analyzing the detection information acquired for the recognition of the traveling environment. For example, the driving assistance ECU 50 can provide the HCU 100 with the analysis results such as a relative position, relative moving speed, and size of another vehicle Ab (see FIG. 10) traveling the left or right adjacent lane based on the detection information from the millimeter-wave radars 32 positioned at the four corners of vehicle A.

The driving assistance ECU 50 allows the processor to execute programs stored in the storage unit and thereby provides multiple function units that embody automated driving or advanced driving assistance. Specifically, the driving assistance ECU 50 includes an ACC control unit, an LTA control unit, and an LCA control unit 51. The ACC control unit provides a function unit that embodies ACC (Adaptive Cruise Control) functions. The ACC control unit causes vehicle A to constantly travel at a target vehicle speed, or causes vehicle A to follow a leading vehicle while maintaining an inter-vehicular distance from the leading vehicle. The ACC control unit successively outputs status information, indicating operating states of the ACC function, to the communication bus 99.

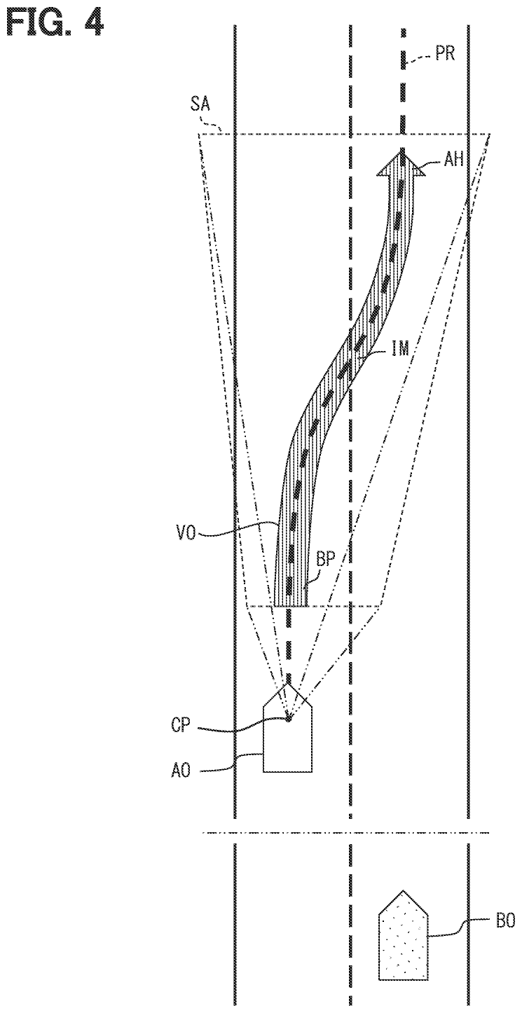

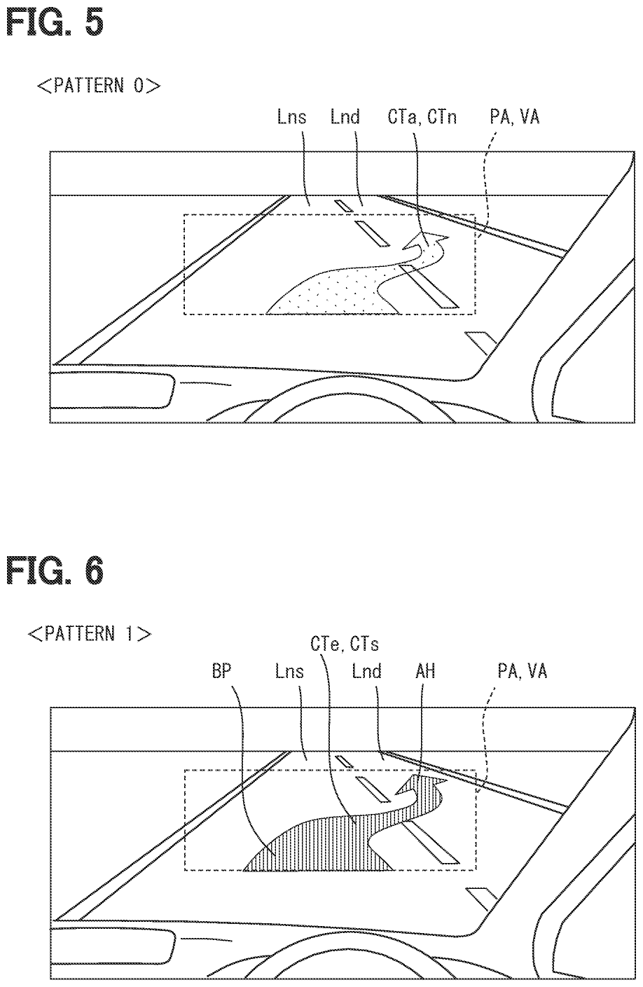

The LTA control unit provides a function unit to embody LTA (Lane Tracing Assist) functions. LTA is also referred to as LTC (Lane Trace Control). The LTA control unit controls steering angles of a steering wheel of vehicle A based on the shape information about lane lines extracted from image data of the front camera 31. The LTA control unit cooperates with the ACC control unit and allows vehicle A to travel according to a traveling line (scheduled travel trace PR, see FIG. 4) generated to follow a lane (subject vehicle lane Lns, see FIG. 5) being currently traveled. The LTA control unit successively outputs status information, indicating operating states of the LTC function, to the communication bus 99.

The LCA control unit 51 provides a function unit to embody an LCA (Lane Change Assist) function. When the LTC function is active, the LCA control unit 51 automatically controls steering angles of the steering wheel and thereby moves vehicle A from subject vehicle lane Lns to the adjacent lane. The LCA control unit 51 activates the LCA function when the driver inputs an on-operation (described later) that allows the driving assistance function to activate the lane change.

When the LCA function is activated, the LCA control unit 51 determines whether another vehicle Ab (see FIG. 10) exists in an adjacent lane (destination lane Lnd, see FIG. 5), namely, the destination as a result of the lane change. Another vehicle Ab to be detected is not limited to a vehicle traveling on destination lane Lnd but may include a vehicle capable of making the lane change from a lane located opposite subject vehicle lane Lns to the destination lane Lnd across destination lane Lnd. If there is another vehicle Ab to prevent the subject vehicle from making the lane change, the LCA control unit 51 enters the standby state to await the lane change. If there is no another vehicle Ab to prevent the subject vehicle from making the lane change, the LCA control unit 51 enters an execution state to start the lane change. The LCA control unit 51 can generate scheduled travel trace PR (see FIG. 4) from subject vehicle lane Lns to destination lane Lnd. In the execution state, the LCA control unit 51 performs the lane change from subject vehicle lane Lns to destination lane Lnd according to the generated scheduled travel trace PR.

When the LCA function is activated based on an on-operation, the LCA control unit 51 successively provides the HCU 100 with lane change information (LC information) about the lane change. The LC information includes at least status information representing the execution state or the standby state and trace shape information representing the shape of generated scheduled travel trace PR. The standby state denotes simply an active state in which the LCA function is activated but does not control the lane change.

The automatic lane change provided by the LCA control unit 51 places an upper limit on the acceleration or motion speed in the sideways direction. Therefore, the shape of scheduled travel trace PR represented by the trace shape information becomes longer in the direction of extending the road corresponding to an increase in the traveling speed indicated by the vehicle speed information. Therefore, the distance required for the lane change also increases.

The DCM (Data Communication Module) 53 provides a communication module mounted on vehicle A. The DCM 53 transmits and receives radio waves to and from base stations around vehicle A through the use of wireless communication compliant with communication standards such as LTE (Long Term Evolution) and 5G. The DCM 53, when mounted, enables vehicle A to be connected to the Internet. The DCM 53 acquires the latest high-precision map data on a road for vehicle A to travel from a cloud-based probe server.

The body ECU 55 is mainly composed of a microcontroller equipped with a processor, RAM, a storage unit, an input/output interface, and a bus connecting these. The body ECU 55 has at least a function to control operations of the lighting devices such as a headlight and a turn signal lamp mounted on vehicle A. The body ECU 55 is electrically connected to a turn signal switch 56.

The turn signal switch 56 is a lever-shaped operation portion provided for a steering column portion 8. The body ECU 55 starts blinking the right or left turn signal lamp corresponding to the operation direction based on the detection of a user operation input to the turn signal switch 56. The turn signal switch 56 is supplied with not only normal user operation to start blinking the turn signal lamp in the state of manual operation, but also the on-operation that instructs the LCA control unit 51 to control the lane change in the active state of the LTC function. For example, the on-operation for the LCA function includes a user operation to half-press the turn signal switch 56 for a predetermined time (such as approximately 1 to 3 seconds). When detecting input of the on-operation for the LCA function, the body ECU 55 outputs on-operation information to the driving assistance ECU 50 and the HCU 100. The on-operation information is notified as information about the on-operation such as the input of the on-operation and the right or left input direction of the on-operation.

The description below explains in detail the operation device 26, the DSM 27, the HUD 20, and the HCU 100 included in the HMI system 10 in turn.

The operation device 26 is an input unit to accept operations by the user such as a driver. The operation device 26 is supplied with user operations to switch between activation and inactivation or change various settings of the ACC function, the LTC function, an air conditioning function, and an audio function, for example. The operation device 26 includes a steering switch provided for a spoke portion of the steering wheel, a touch panel integrated with the display of the navigation system, and an operation lever provided for the steering column portion 8, for example.

The DSM 27 includes a near-infrared light source, a near-infrared camera, and a control unit to control these. The DSM 27 is installed on the upper surface of the steering column portion 8 or the upper surface of the instrument panel 9, for example, so that the near-infrared camera faces the headrest portion of the driver's seat. The DSM 27 uses the near-infrared camera to capture the driver's head to which the near-infrared light is irradiated from the near-infrared light source. The control unit applies image analysis to images captured by the near-infrared camera. The control unit extracts information such as positions and eye directions of eyepoint EP from the captured image and successively outputs the extracted state information to the HCU 100.

The HUD 20 is mounted on vehicle A as one of the multiple in-vehicle display devices along with a meter display and a central information display. The HUD 20 is electrically connected to the HCU 100 and successively acquires video data generated by the HCU 100. Based on the video data, the HUD 20 uses virtual image Vi to provide the driver with various information about vehicle A such as route information, sign information, and control information about the in-vehicle functions.

The HUD 20 is housed in the accommodation space inside the instrument panel 9 below windshield WS. The HUD 20 projects the light formed as virtual image Vi toward projection range PA of windshield WS. The light projected on windshield WS is reflected toward the driver's seat in projection range PA and is perceived by the driver. The driver visually recognizes a display superimposed with virtual image Vi on the foreground visible through projection range PA.

The HUD 20 includes a projector 21 and an enlarging optical system 22. The projector 21 includes an LCD (Liquid Crystal Display) panel and a backlight. The projector 21 is fixed to the housing of the HUD 20 so that the display surface of the LCD panel faces the enlarging optical system 22. The projector 21 displays each frame image of the video data on the display surface of the LCD panel, applies transmitted illumination to the display surface using a backlight, and thereby emits the light formed as virtual image Vi toward the enlarging optical system 22. The enlarging optical system 22 includes at least one concave mirror formed by vapor depositing a metal such as aluminum on the surface of a base material made of synthetic resin or glass. The enlarging optical system 22 spreads the light emitted from the projector 21 by reflection and projects the light onto projection range PA positioned above.

The HUD 20 is given the angle of view VA. Suppose imaging plane IS corresponds to a virtual range in the space where virtual image Vi can be imaged on the HUD 20. Then, the angle of view VA represents a viewing angle defined based on a virtual line connecting the driver's eyepoint EP and the outer edge of imaging plane IS. The angle of view VA is comparable to an angle range that enables the driver to visually recognize virtual image Vi viewed from eyepoint EP. The HUD 20 allows the horizontal angle of view (approximately 10 through 12 degrees, for example) in the horizontal direction to be larger than the vertical angle of view (approximately 4 through 5 degrees, for example) in the vertical direction. When viewed from eyepoint EP, a front range (a range of approximately a dozen to 100 meters, for example) overlapping imaging plane IS corresponds to the range within the angle of view VA.

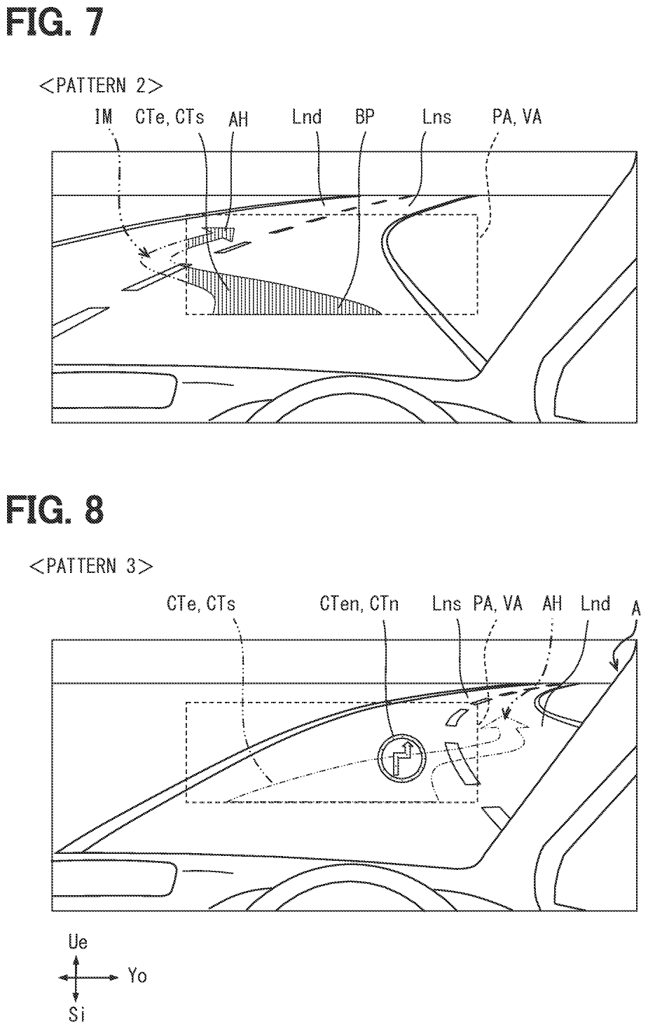

The HUD 20 displays superimposition content CTs (see FIGS. 6 and 7) and non-superimposition content CTn (see FIGS. 5 and 8) as virtual images Vi. Superimposition content CTs is an AR display object used for augmented reality (AR) display. A display position of superimposition content CTs is associated with a superimposition target, as a specified superimposition target, existing in the foreground, such as a road surface, a leading vehicle, a pedestrian, and a road sign. The superimposition content CTs is displayed to superimpose on a specified superimposition target in the foreground and is seemingly fixed relative to the specified superimposition target to be able to follow the specified superimposition target corresponding to the driver's eye line. Namely, the relative positional relationship is continuously maintained among the driver's eyepoint EP, the superimposition target in the foreground, and superimposition content CTs. Therefore, the shape of superimposition content CTs is continuously updated at a predetermined cycle according to the relative position and shape of the superimposition target. The superimposition content CTs is displayed to be approximately leveled compared to non-superimposition content CTn and provides a display shape extending in the depth direction when viewed from the driver, for example.

The non-superimposition content CTn is a non-AR display object belonging to the display objects displayed to superimpose on the foreground except superimposition content CTs. Unlike superimposition content CTs, non-superimposition content CTn is displayed to superimpose on the foreground independently of the superimposition target. The display position of non-superimposition content CTn is not associated with the specific superimposition target. Non-superimposition content CTn is displayed at a predetermined position within projection range PA. Therefore, non-superimposition content CTn is displayed as if it is relatively fixed to a vehicle configuration such as windshield WS. In addition, non-superimposition content CTn substantially has a constant shape. Even non-superimposition content CTn may be displayed to superimpose on a superimposition target of superimposition content CTs depending on the positional relationship between vehicle A and the superimposition target.

The HCU 100 is an electronic control apparatus that integratively controls displays of multiple in-vehicle display devices including the HUD 20 in the HMI system 10. For example, the HCU 100 and the HUD 20 configure a virtual image display system.

The HCU 100 is mainly composed of a computer equipped with a processing unit 11, RAM 12, a storage unit 13, an input/output interface 14, and a bus connecting these. The processing unit 11 is the hardware combined with the RAM 12 for arithmetic processing. The processing unit 11 includes at least one arithmetic core such as a CPU (Central Processing Unit) or a GPU (Graphics Processing Unit). The processing unit 11 may further include an FPGA (Field-Programmable Gate Array), an NPU (Neural network Processing Unit), and other IP cores having dedicated functions, for example. The RAM 12 may include video RAM for video generation. The processing unit 11 accesses the RAM 12 to perform various processes to embody the functions of function units described later. The storage unit 13 includes a non-volatile storage medium. The storage unit 13 stores various programs (such as a display control program) executed by the processing unit 11.

The HCU 100 illustrated in FIGS. 1 through 3 includes multiple function units that control the superimposing display of contents via the HUD 20 by allowing the processing unit 11 to execute the display control program stored in the storage unit 13. Specifically, the HCU 100 configures the function units such as a viewpoint position identification unit 71, a vehicle information acquisition unit 72, an external information acquisition unit 73, a position information acquisition unit 74, a state determination unit 75, and a display generation unit 76.

The viewpoint position identification unit 71 identifies positions of eyepoint EP of the driver sitting in the driver's seat based on the state information acquired from the DSM 27. The viewpoint position identification unit 71 generates three-dimensional coordinates (eyepoint coordinates) indicating positions of eyepoint EP and successively supplies the generated eyepoint coordinates to the display generation unit 76.

The vehicle information acquisition unit 72 acquires at least on-operation information output to the communication bus 99 by the body ECU 55, status information on the LTA function output to the communication bus 99 by the LTA control unit, and LC information output to the communication bus 99 by the LCA control unit 51, for example. The vehicle information acquisition unit 72 successively provides the display generation unit 76 with the trace shape information contained in the LC information. Further, the vehicle information acquisition unit 72 successively provides the state determination unit 75 with the status information on the LCA function.

The external information acquisition unit 73 acquires the detection information about the range around vehicle A, particularly the range including destination lane Lnd (see FIG. 5, for example) from at least the proximity monitoring sensor 30 or the driving assistance ECU 50. The detection information may be available as information before the analysis such as imaging data of the front camera 31 and measurement data of the millimeter-wave radar 32 as well as analysis results acquired from the driving environment recognition by the driving assistance ECU 50. Based on the acquired detection information, the external information acquisition unit 73 recognizes the existence of another vehicle Ab that may interfere with the lane change made by the subject vehicle. When recognizing the existence of another vehicle Ab, the external information acquisition unit 73 provides the display generation unit 76 with relative position information and size information on another vehicle Ab.

The position information acquisition unit 74 acquires the latest position information and the direction information about vehicle A as the subject vehicle position information from the locator ECU 44. The position information acquisition unit 74 also acquires high-precision map data of the range around vehicle A from the locator ECU 44. The position information acquisition unit 74 may acquire the high-precision map data from a probe server, for example, via the DCM 53. The position information acquisition unit 74 successively provides the display generation unit 76 with the acquired subject vehicle position information and high-precision map data.

The state determination unit 75 determines whether the LCA control unit 51 provides the lane change control in the execution state or standby state, based on the status information provided by the vehicle information acquisition unit 72. The state determination unit 75 successively provides the display generation unit 76 with the state determination result based on the status information.

The display generation unit 76 generates video data successively output to the HUD 20 and thereby controls the HUD 20 to provide the driver with information. The display generation unit 76 draws an original image of each content displayed as virtual image Vi on individual frame images composing the video data. When drawing the original image of superimposition content CTs (see FIG. 6) on the frame image, the display generation unit 76 corrects the drawing position and the drawing shape of the original image in the frame image depending on positions of eyepoint EP and the superimposition target. When viewed from eyepoint EP, superimposition content CTs is then displayed at the position and in the shape to be correctly superimposed on the superimposition target.

The display generation unit 76 further includes a virtual layout function and a content selection function to embody the above-mentioned video data generation function. The virtual layout function simulates the display layout of superimposition content CTs (see FIG. 6) based on various information provided to the display generation unit 76. When the vehicle information acquisition unit 72 acquires the status information indicating the execution state of lane change, the display generation unit 76 reproduces the current travel environment of vehicle A in the virtual space based on the subject vehicle position information and the high-precision map data.

To be more specific, as illustrated in FIGS. 2 through 4, the display generation unit 76 places subject vehicle object AO at a reference position in the virtual three-dimensional space. Based on the subject vehicle position information, the display generation unit 76 maps a road model, shaped according to the high-precision map data, to the three-dimensional space in association with subject vehicle object AO. The display generation unit 76 sets scheduled travel trace PR, shaped according to the trace shape information, on the road model. When another vehicle Ab exists, the display generation unit 76 places another vehicle object BO sized according to the size information of another vehicle Ab based on the relative location information of another vehicle Ab (see FIG. 10). Moreover, the display generation unit 76 sets virtual camera position CP and superimposition range SA in association with subject vehicle object AO.

The virtual camera position CP provides a virtual position corresponding to the driver's eyepoint EP. The display generation unit 76 successively corrects virtual camera position CP for subject vehicle object AO based on the latest eyepoint coordinates acquired by the viewpoint position identification unit 71. The superimposition range SA enables the superimposing display of virtual image Vi. The display generation unit 76 sets superimposition range SA based on virtual camera position CP and outer edge position (coordinate) information on projection range PA previously stored in the storage unit 13 (see FIG. 1), for example. Superimposition range SA is comparable to a front range positioned inside projection range PA when viewed forward from virtual camera position CP. Superimposition range SA corresponds to the angle of view VA of the HUD 20.

The display generation unit 76 positions an arrow-shaped virtual object VO on the road surface of a road model in the three-dimensional space. Virtual object VO follows scheduled travel trace PR. Virtual object VO is positioned to overlap with scheduled travel trace PR and is shaped to extend along the road model. Virtual object VO is shaped corresponding to fulfillment notification content CTe (see FIG. 6) described later. The shape of virtual object VO viewed from virtual camera position CP corresponds to the virtual image shape of fulfillment notification content CTe visually recognized from eyepoint EP. When the road model is curved in the scene of traveling a curve, scheduled travel trace PR and virtual object VO are also shaped to correspond to the road model.

The content selection function selects contents used to present the information. When the LCA function is enabled based on the driver's on-operation, the display generation unit 76 selects the contents to be drawn in the video data based on the status information on the LCA function and the simulation result of the display layout. The display generation unit 76 presents the information related to the lane change control by appropriately using superimposition content CTs and non-superimposition content CTn.

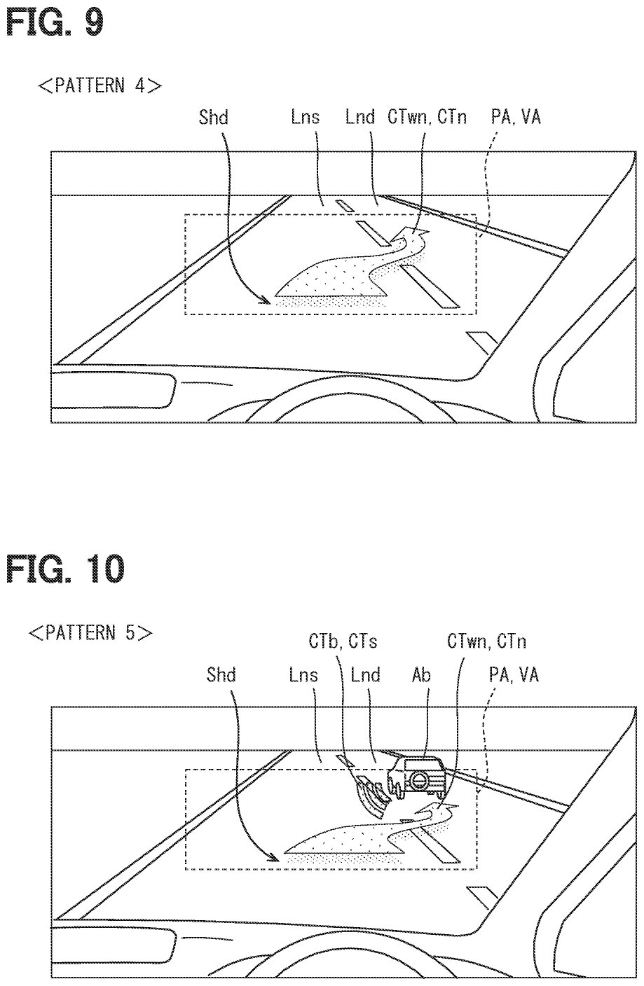

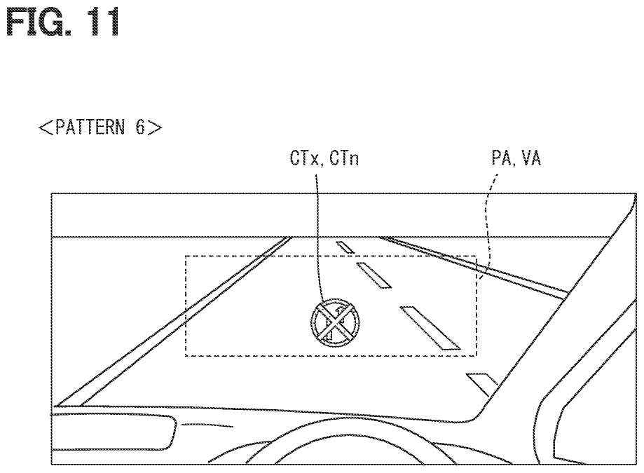

The contents drawn by the display generation unit 76 include response notification content CTa (see FIG. 5), fulfillment notification content CTe (see FIGS. 6 and 7), fulfillment notification icon CTen (see FIG. 8), and standby notification content CTwn (see FIGS. 9 and 10). The contents drawn by the display generation unit 76 further include different vehicle notification icon CTb (see FIG. 10) and time-out notification icon CTx (see FIG. 11). The description below explains in detail the displays of patterns 0 through 7 in turn including those contents based on FIGS. 5 through 13 by reference to FIGS. 1 through 4.

<Display of Pattern 0>

As illustrated in FIG. 5, the display state of “pattern 0” displays response notification content CTa. Response notification content CTa is a display object notifying the driver that the on-operation input to the turn signal switch 56 is accepted. The display of response notification content CTa starts based on the acquisition of on-operation information by the vehicle information acquisition unit 72. The display of response notification content CTa continues until the LCA control unit 51 finishes checking the environment around the vehicle and the vehicle information acquisition unit 72 acquires the status information on the LCA function.

Response notification content CTa is a non-superimposition content CTn and maintains a predetermined shape from the beginning to the end of the display. Response notification content CTa is drawn in a shape associated with fulfillment notification content CTe (see FIG. 6). Specifically, response notification content CTa is shaped into an arrow extending from subject vehicle lane Lns to destination lane Lnd. The control given to the lane change to the right lane displays arrow-shaped response notification content CTa extending from subject vehicle lane Lns to the right front. The control given to the lane change to the left lane displays arrow-shaped response notification content CTa extending from subject vehicle lane Lns to the left front. Defined as non-superimposition content CTn, response notification content CTa may be displayed with its tip misaligned with destination lane Lnd due to the curvature and the slope of a road being traveled.

<Display of Pattern 1>

As illustrated in FIG. 6, the display state of “pattern 1” displays the entire fulfillment notification content CTe. Fulfillment notification content CTe is comparable to superimposition content CTs that indicates the fulfillment schedule of lane changes made by the LCA control unit 51 and the execution state of the lane change. The display of fulfillment notification content CTe starts when the vehicle information acquisition unit 72 acquires the status information indicating the execution state. Fulfillment notification content CTe assumes road surfaces of subject vehicle lane Lns and destination lane Lnd in the foreground to be superimposition targets and is displayed in a shape that is displayed to superimpose on subject vehicle lane Lns and destination lane Lnd.

The drawing shape of fulfillment notification content CTe is determined based on the simulation result of the display layout. Therefore, fulfillment notification content CTe is shaped into an arrow indicating an estimated path (scheduled travel trace PR) of vehicle A. Point part AH of fulfillment notification content CTe is positioned at destination lane Lnd and indicates the direction in which vehicle A travels after the lane change. Base part BP of fulfillment notification content CTe is positioned at subject vehicle lane Lns. Fulfillment notification content CTe is updated to the latest shape in synchronization with the update cycle (such as 10 ms) of scheduled travel trace PR generated by the LCA control unit 51. As a result, fulfillment notification content CTe continues to be displayed while the shape is updated until the lane change control is complete.

The display color of fulfillment notification content CTe differs from the display colors of response notification content CTa and standby notification content CTwn. The display brightness of fulfillment notification content CTe differs from the display brightnesses of response notification content CTa and standby notification content CTwn and is set higher than these display brightnesses.

During the display layout simulation (see FIG. 4), the display generation unit 76 determines whether fulfillment notification content CTe overreaches the angle of view VA based on whether virtual object VO overreaches superimposition range SA. When the entire virtual object VO is positioned in superimposition range SA, the display generation unit 76 determines that fulfillment notification content CTe does not overreach the angle of view VA. In this case, the display generation unit 76 displays the entire fulfillment notification content CTe as virtual image Vi according to the display state of “pattern 1.”

<Display of Pattern 2>

As illustrated in FIG. 7, the display state of “pattern 2” splittingly displays fulfillment notification content CTe. When point part AH of virtual object VO remains in superimposition range SA, the display generation unit 76 determines that fulfillment notification content CTe does not overreach the angle of view VA even if the other parts except point part AH overreach superimposition range SA. In this case, fulfillment notification content CTe is displayed as a virtual image that lacks intermediate part IM (see the dash-dot-dot-dash line in FIG. 7) and contains point part AH and base part BP separated from each other. Even if intermediate part IM overreaches the angle of view VA and is invisible, fulfillment notification content CTe can use point part AH and base part BP to provide the driver with an estimated path based on the lane change. One display state of “pattern 2” displays fulfillment notification content CTe in the shape containing a partially missing part.

<Display of Pattern 3>

As illustrated in FIG. 8, the display state of “pattern 3” displays fulfillment notification icon CTen instead of fulfillment notification content CTe. The display generation unit 76 determines that fulfillment notification content CTe overreaches the angle of view VA when point part AH of virtual object VO overreaches superimposition range SA during the display layout simulation (see FIG. 4).

Point part AH indicates the future position of the subject vehicle when the lane change is completed after a predetermined time. Suppose the lane change requires the predetermined time of approximately 8 seconds and the vehicle speed is 100 km/h. Then, point part AH is superimposed on the road surface 222 meters away from the current position. It is practically impossible to always keep the subject vehicle position within the angle of view VA after the predetermined time. Therefore, when fulfillment notification content CTe overreaches the angle of view VA, the display generation unit 76 hides fulfillment notification content CTe (see the dash-dot-dot-dash line in FIG. 8) and displays fulfillment notification icon CTen.

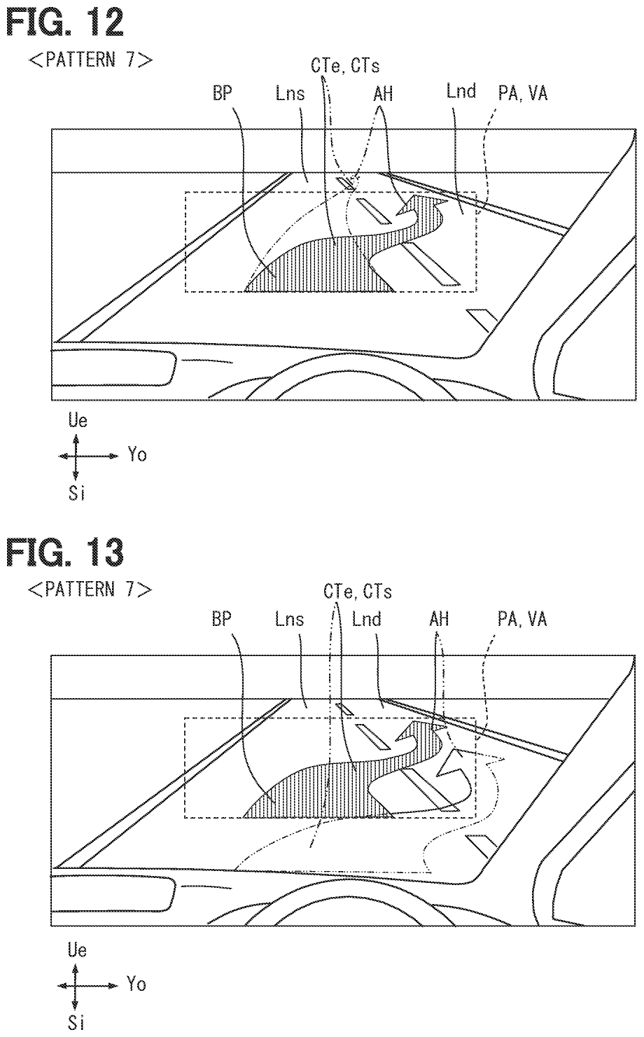

Furthermore, the display generation unit 76 determines whether destination lane Lnd overreaches the angle of view VA. The display generation unit 76 determines that destination lane Lnd overreaches the angle of view VA when the angle of view VA does not cover a road surface area capable of superimposing point part AH. Such an excess of destination lane Lnd is caused by the curve shape or the slope shape of a road being traveled. Destination lane Lnd may overreach the angle of view VA or, in other words, point part AH may entirely overreach the angle of view VA toward sideways Yo. In this case, the display generation unit 76 displays “pattern 3” including fulfillment notification icon CTen. Point part AH may overreach the angle of view VA and destination lane Lnd may remain in the angle of view VA. In this case, the display generation unit 76 displays “pattern 7” described later (see FIGS. 12 and 13).

Similar to fulfillment notification content CTe, fulfillment notification icon CTen is the content that indicates the execution state of lane change made by the LCA control unit 51. Fulfillment notification icon CTen is a display object containing an arrow-shaped center image portion and an outer image portion. The center image portion bends toward destination lane Lnd and indicates the travel direction (upward denoted as Ue). The outer image portion circularly surrounds the arrow shape. Fulfillment notification icon CTen is displayed through the use of substantially the same display color and display brightness as used for fulfillment notification content CTe. Unlike fulfillment notification content CTe, fulfillment notification icon CTen is a non-superimposition content CTn independent of the superimposition target and is displayed to face the driver. Fulfillment notification icon CTen is stationarily displayed at a specific position in projection range PA. Such a specific position may correspond to the position to start the steering control visible from eyepoint EP at a specific timing, namely, the position to induce a sideways acceleration. Fulfillment notification icon CTen is continuously displayed while maintaining the specified shape until the completion of the lane change control.

<Display of Pattern 4>

As illustrated in FIG. 9, the display state of “pattern 4” displays standby notification content CTwn in the reference shape. Standby notification content CTwn is a non-superimposition content CTn indicating that the LCA control unit 51 keeps the lane change in the standby state. Standby notification content CTwn is continuously displayed while maintaining a specified shape during the period in which the vehicle information acquisition unit 72 acquires the status information indicating the standby state of the lane change. Standby notification content CTwn has a shape related to fulfillment notification content CTe, specifically, an arrow shape extending from subject vehicle lane Lns to destination lane Lnd like response notification content CTa. The extension direction of standby notification content CTwn corresponds to the moving direction of vehicle A under the lane change control. The display color and display brightness of standby notification content CTwn may be substantially the same as response notification content CTa or may differ from response notification content CTa.

Unlike response notification content CTa, standby notification content CTwn is displayed to superimpose on the foreground in such a manner as to float over the road surface. Shadow Shd is displayed on the road surface below standby notification content CTwn to apply a floating effect to standby notification content CTwn. For example, shadow Shd is displayed through the use of a display color similar to standby notification content CTwn and the lower display brightness than standby notification content CTwn. The transition from response notification content CTa to standby notification content CTwn causes a display change that allows the arrow shape to float over the road surface. The transition from standby notification content CTwn to fulfillment notification content CTe causes a display change that sticks the arrow shape to the road surface.

The display generation unit 76 determines whether standby notification content CTwn needs to correct the shape based on whether another vehicle object BO enters superimposition range SA during the display layout simulation. Another vehicle object BO may entirely overreach superimposition range SA. In other words, another vehicle Ab may overreach the angle of view VA. In this case, the display generation unit 76 displays “pattern 4” containing standby notification content CTwn in the reference shape.

<Display of Pattern 5>

As illustrated in FIG. 10, the display state of “pattern 5” displays standby notification content CTwn and different vehicle notification icon CTb at a time. The display generation unit 76 corrects the shape of standby notification content CTwn when another vehicle object BO enters superimposition range SA during the display layout simulation. Specifically, the display generation unit 76 corrects the shape of standby notification content CTwn to avoid overlap with another vehicle Ab in the foreground. For example, standby notification content CTwn is transformed into a shape that is reduced in the vertical (front-back) direction.

Different vehicle notification icon CTb is a superimposition content CTs that notifies the driver of the existence of another vehicle Ab as a cause of the standby state. Different vehicle notification icon CTb is displayed as a virtual image to face the driver, emphasizing another vehicle Ab in the foreground. The display position of different vehicle notification icon CTb is adjusted in the angle of view VA according to the relative position of another vehicle Ab to be positioned near another vehicle Ab in the foreground and not to overlap standby notification content CTwn.

<Display of Pattern 6>

As illustrated in FIG. 11, the display state of “pattern 6” displays time-out notification icon CTx. Time-out notification icon CTx is a non-superimposition content CTn notifying the driver that the LCA control unit 51 stops the lane change control. Time-out notification icon CTx is continuously displayed for a specified period when the standby state exceeds a predetermined upper limit (such as approximately 20 seconds) and the lane change control by the LCA control unit 51 is canceled.

The drawing shape of time-out notification icon CTx is related to fulfillment notification icon CTen so that fulfillment notification icon CTen overlaps an “x” symbol indicating negation. Time-out notification icon CTx uses a display color different from fulfillment notification icon CTen, specifically, a display color such as amber to promote awareness.

<Display of Pattern 7>

As illustrated in FIGS. 12 and 13, the display state of “pattern 7” displays a transformed version of fulfillment notification content CTe. Fulfillment notification content CTe is drawn to trace scheduled travel trace PR in the above-mentioned display states of “pattern 1” and “pattern 2” (see FIG. 4). In the display state of “pattern 7,” however, fulfillment notification content CTe is superimposed on a position different from the actual scheduled travel trace PR.

Specifically, according to the traveling scene illustrated in FIG. 12, the completion point of the lane change is distant from the subject vehicle and is therefore destined for Ue that is further above the upper edge of the angle of view VA. Therefore, point part AH disappears toward Ue beyond the angle of view VA (see the dash-dot-dot-dash line in FIG. 12) when an attempt is made to display fulfillment notification content CTe by accurately tracing scheduled travel trace PR.

When point part AH overreaches toward Ue above the angle of view VA, the display generation unit 76 displays fulfillment notification content CTe to be superimposed at the position shifted toward the subject vehicle (downward denoted as Si) based on scheduled travel trace PR. The display generation unit 76 transforms fulfillment notification content CTe from the reference shape so that point part AH is entirely drawn on the road surface of destination lane Lnd in the angle of view VA.

The display generation unit 76 gradually reduces the amount of deviation in fulfillment notification content CTe from scheduled travel trace PR while vehicle A travels. Consequently, fulfillment notification content CTe, superimposed at a position different from scheduled travel trace PR, returns to the original drawing shape superimposed on scheduled travel trace PR during the sideways movement toward destination lane Lnd.

According to the traveling scene in FIG. 13, the lane change control directly transitions to the execution state without the standby state. Therefore, scheduled travel trace PR is entirely positioned toward the subject vehicle (downward Si) below the angle of view VA. Therefore, if an attempt is made to display fulfillment notification content CTe that accurately reproduces scheduled travel trace PR, almost the whole of base part BP of fulfillment notification content CTe deviates downward Si below the angle of view VA (see the dash-dot-dot-dash line in FIG. 13).

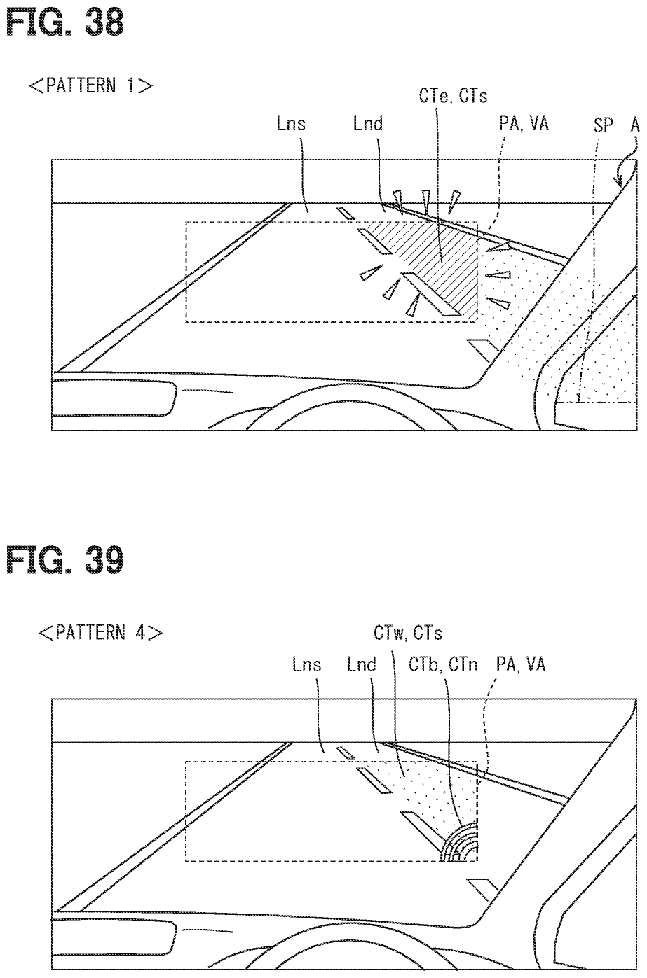

The display generation unit 76 also transforms the schedule notification content when base part BP and point part AH overreach the angle of view VA toward the subject vehicle (downward Si). The display generation unit 76 superimposes fulfillment notification content CTe at a position shifted in the travel direction (upward Ue) based on scheduled travel trace PR and displays almost the whole of base part BP and point part AH in the angle of view VA. The display of “pattern 7” described so far may use fulfillment notification content CTe to fill destination lane Lnd (see FIG. 38) instead of the arrow-shaped fulfillment notification content CTe.

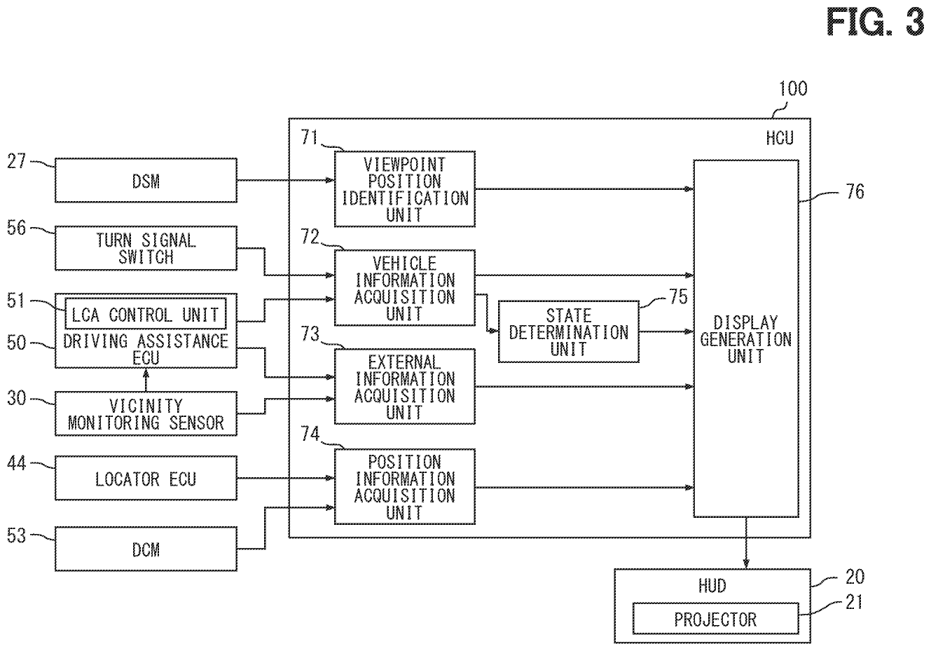

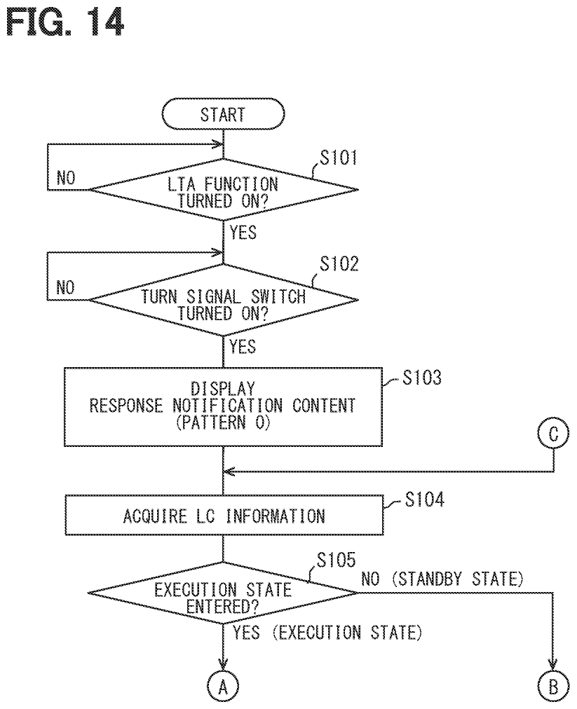

Based on flowcharts illustrated in FIGS. 14 through 16, the description below explains in detail a display control method to switch displays of patterns 0 through 7 related to the LCA function based on the display control program by reference to FIGS. 3 and 5 through 13 as appropriate. The display control process in FIGS. 14 through 16 starts when the power of vehicle A is turned on to start the power supply to the HCU 100, for example.

At S101, the process determines whether the LTA control unit turns on the LTA function, based on the status information on the LTA function acquired by the vehicle information acquisition unit 72. At S101, it may be determined that the LTA function does not turn on. Then, the process repeats the determination at S101 to maintain the standby state. At this time, the process disallows at least the virtual image display related to the LCA function. It may be determined that the LTA function turns on. Then, the process proceeds to S102.

At S102, the process determines whether the on-operation to control the lane change is input to the turn signal switch 56, based on whether the vehicle information acquisition unit 72 acquires the on-operation information. At S102, it may be determined that no on-operation is input. Then, the process repeats the determination at S102 to maintain the standby state. Also at this time, the process disallows at least the virtual image display related to the LCA function. It may be determined that the on-operation is input to the turn signal switch 56 based on the acquisition of the on-operation information. Then, the process proceeds to S103.

At S103, the process starts displaying pattern 0 (see FIG. 5) including response notification content CTa and proceeds to S104. The display of response notification content CTa notifies the driver that the instruction to make a lane change is received.

At S104, the process acquires LC information and proceeds to S105. However, the process at S104 allows the LCA control unit 51 to wait to start outputting the LC information during an initial period in which the LCA control unit 51 checks the surrounding situations. At this time, response notification content CTa is continuously displayed, notifying the driver that the surrounding situations are checked normally.

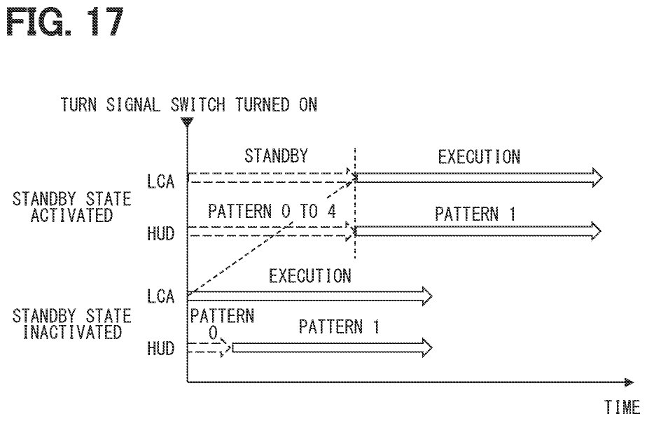

At S104, the LC information can be immediately acquired in a system that allows the LCA control unit 51 to constantly monitor surrounding situations. Even such a system continues the display state of pattern 0 including response notification content CTa for at least a predetermined time (see FIG. 17).

At S105, the process determines whether the lane change enters the execution state or the standby state, based on the status information of the LC information acquired at S104. At S105, it may be determined that the lane change enters the execution state instead of the standby state. Then, the process proceeds to S106.

At S106, the process determines whether the angle of view VA entirely covers fulfillment notification content CTe, based on the simulation result of a display layout. At S106, it may be determined that the angle of view VA entirely covers fulfillment notification content CTe. Then, the process proceeds to S107. At S107, the process displays fulfillment notification content CTe in the reference shape, instead of response notification content CTa or standby notification content CTwn, to be superimposed on the road surface in the foreground. Then, the display control process terminates. The display of pattern 1 (see FIG. 6) started at S107 continues until the completion of the lane change control while updating the superimposed shape of fulfillment notification content CTe.

At S106, it may be determined that at least part of fulfillment notification content CTe overreaches the angle of view VA. Then, the process proceeds to S108. At S108, the process further determines whether the angle of view VA covers point part AH of fulfillment notification content CTe. At S108, it may be determined that the angle of view VA entirely covers point part AH. Then, the process proceeds to S109. At S109, the process displays fulfillment notification content CTe including at least point part AH to be superimposed on the road surface in the foreground. Then, the display control process terminates. The display of pattern 2 (see FIG. 7) started at S109 continues until the completion of the lane change control while updating the superimposed shape of fulfillment notification content CTe.

At S108, it may be determined that point part AH overreaches the angle of view VA. Then, the process proceeds to S120. At S120, the process determines whether destination lane Lnd overreaches the angle of view VA. At S120, it may be determined that the angle of view VA sufficiently covers the road surface of destination lane Lnd. Then, the process proceeds to S109. At S109 in this case, the process displays fulfillment notification content CTe in a transformed drawing shape to be superimposed at a position different from scheduled travel trace PR. Then, the display control process terminates. The display of this pattern 7 (see FIGS. 12 and 13) also continues until the completion of the lane change control while updating the superimposed shape of fulfillment notification content CTe.

At S120, it may be determined that destination lane Lnd overreaches the angle of view VA, in other words, point part AH is assumed to overreach due to the curve shape. Then, the process proceeds to S110. At S110, fulfillment notification icon CTen, as a non-superimposition content CTn, is displayed in the foreground in a superimposing manner. Then, the display control process terminates. At S110, fulfillment notification content CTe is hidden. The display of pattern 3 (see FIG. 8) started at S109 also continues until the completion of the lane change control.

At S105, it may be determined that the lane change enters the standby state. Then, the process proceeds to S111. At S111, the process determines whether the continuation of the standby state causes time-out to the lane change control by the LCA control unit 51. The LCA control unit 51 causes the accepted lane change control to time out when the standby state continues 20 seconds or longer, for example. At S111, it may be determined that the lane change control times out. Then, the process proceeds to S115. At S115, the process starts displaying pattern 6 (see FIG. 11) including time-out notification icon CTx. Then, the display control process terminates. The display of pattern 6 started at S115 continues for a predetermined time. The display of time-out notification icon CTx notifies the driver that the lane change control, once activated, has timed out.

At S111, it may be determined that the lane change control does not time out. Then, the process proceeds to S112. At S112, the process determines whether another vehicle Ab causing the standby state is positioned in the angle of view VA. At S112, it may be determined that another vehicle Ab is positioned outside the angle of view VA. Then, the process proceeds to S113. At S113, the process starts displaying pattern 4 (see FIG. 9) including standby notification content CTwn in the reference shape and then returns to S104.

At S112, it may be determined that another vehicle Ab is positioned in the angle of view VA. Then, the process proceeds to S114. At S114, the process starts displaying pattern 5 (see FIG. 10) including standby notification content CTwn transformed to avoid another vehicle Ab and different vehicle notification icon and then returns to S104. The displays at S113 and S114 including standby notification content CTwn continue during the standby state. The state transition from the standby state to the execution state causes the display transition from standby notification content CTwn to fulfillment notification content CTe.

The first embodiment described so far displays fulfillment notification icon CTen as non-superimposition content CTn when fulfillment notification content CTe as superimposition content CTs overreaches the angle of view VA of the HUD 20. Fulfillment notification icon CTen is a non-superimposition content CTn independent of a superimposition target and therefore does not practically overreach due to the travel environment of vehicle A. The HCU 100 can provide the lane change fulfillment schedule in an easy-to-understand manner despite possible limitations on the angle of view VA of the HUD 20.

In addition, the first embodiment hides fulfillment notification content CTe when fulfillment notification content CTe overreaches the angle of view VA. Only fulfillment notification icon CTen as a non-superimposition content CTn is displayed. Therefore, it is possible to avoid a situation in which the display of incompletely shaped fulfillment notification content CTe hinders the driver from recognizing the information.

Further, the first embodiment continues the display of the arrow-shaped fulfillment notification content CTe indicating scheduled travel trace PR when point part AH is positioned in the angle of view VA. As described above, the mere display of the arrow-shaped point part AH enables the driver to understand the meaning even if intermediate part IM overreaches. Suppose point part AH is used as the main part for the overreach determination and the determination is made as to whether fulfillment notification content CTe is displayed continuously. Then, fulfillment notification content CTe can provide information in many scenes. As a result, it is possible to present an estimated trace of vehicle A and thereby notify the driver of the lane change fulfillment schedule in an easy-to-understand manner.

Further, the first embodiment starts displaying response notification content CTa as a non-superimposition content CTn based on the acquisition of the on-operation information. Therefore, the driver can recognize that the system has normally accepted input of the on-operation to trigger the lane change. The driver can increase the feeling of reliability in the automatic lane change control.

Response notification content CTa is a non-superimposition content CTn independent of a superimposition target. There is no need for a process that identifies superimposition targets, making it possible to start displaying response notification content CTa in quick response to the on-operation. The driver can feel improved operability.

According to the first embodiment, the fulfillment notification content CTe is transformed so that point part AH is positioned in the angle of view VA. Therefore, the arrow-shaped fulfillment notification content CTe is presented to the driver even if the lane change is accomplished at a position that is distant from the subject vehicle or is very close to the subject vehicle. It is possible to provide the driver with future travel traces under the lane change control in many driving scenes in an easy-to-understand manner despite possible limitations on the angle of view VA of the HUD 20.

The first embodiment displays fulfillment notification icon CTen instead of fulfillment notification content CTe when destination lane Lnd overreaches the angle of view VA. Therefore, fulfillment notification content CTe is not displayed when point part AH overreaches the angle of view VA due to a curve. It is possible to avoid a situation in which the driver while traveling a curve, feels annoyed with the display of fulfillment notification content CTe representing a curved shape different from the shape of the curve.

As illustrated in FIG. 17, the first embodiment displays pattern 0 including response notification content CTa even when the LCA control unit 51 performs the lane change immediately after the on-operation on the turn signal switch 56 to trigger the lane change. It is possible to lower the driver's anxiety about an immediately started lane change by substantially always displaying response notification content CTa regardless of whether the lane change control enters the standby state.

In the first embodiment, the LCA control unit 51 is comparable to a “lane change control unit.” The vehicle information acquisition unit 72 is comparable to an “information acquisition unit.” The display generation unit 76 is comparable to a “display control unit.” Point part AH is comparable to a “tip portion.” Fulfillment notification content CTe is comparable to a “schedule notification content.” The HCU 100 is comparable to a “display control device.”

### Second Embodiment

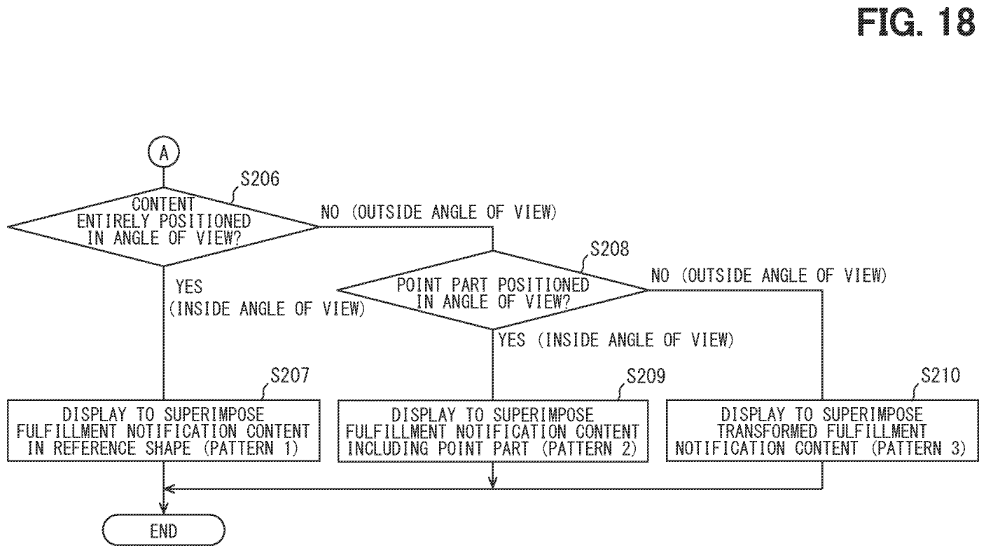

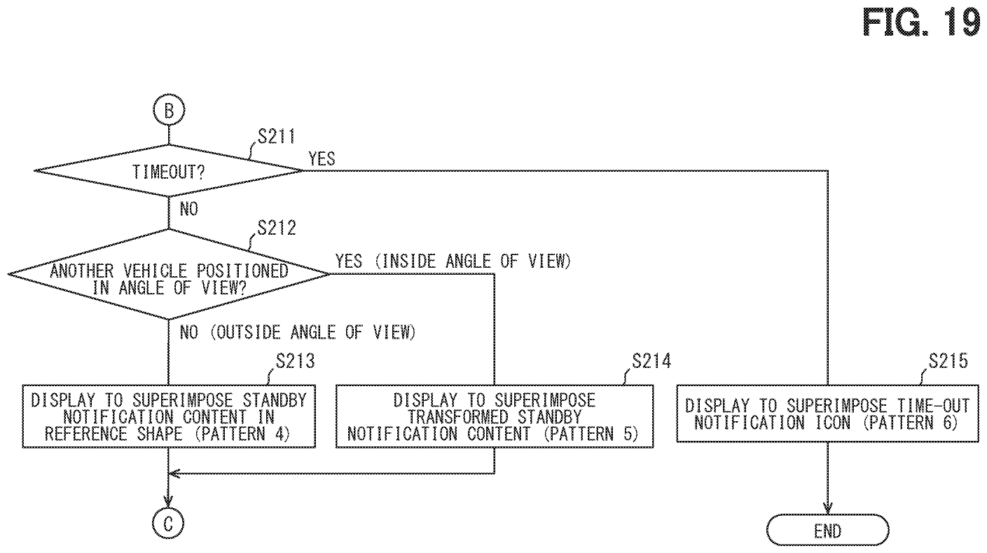

The second embodiment of the present disclosure illustrated in FIGS. 18 through 23 is a modification of the first embodiment. The second embodiment differs from the first embodiment in part of the contents displayed based on the display control method illustrated in FIGS. 18 and 19. Specifically, displays of patterns 0, 3, 4, and 5 differ from those of the first embodiment. The description below explains in detail the pattern displays in turn.

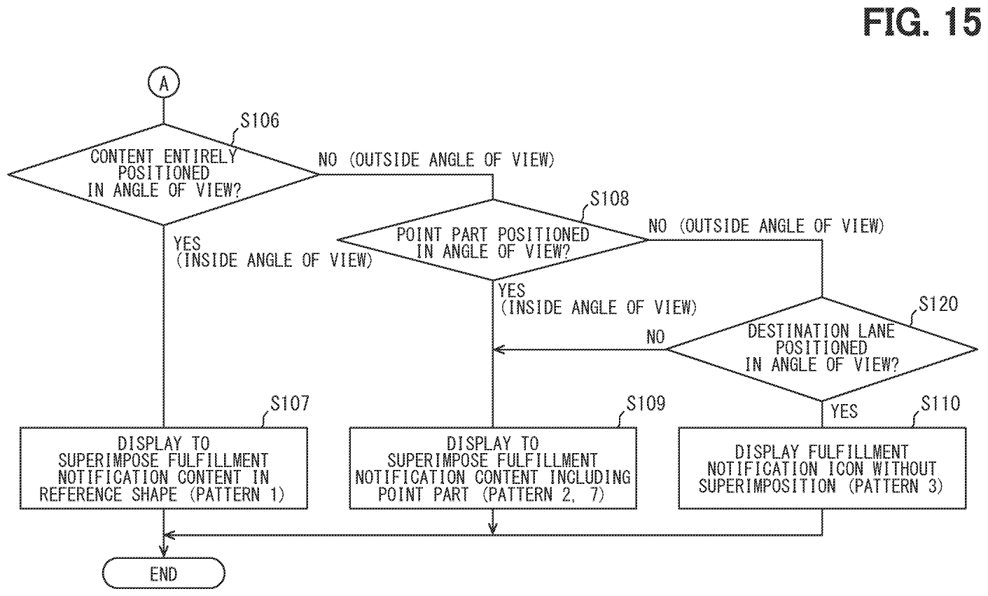

The displays of patterns 1, 2, and 6 are substantially the same as those of the first embodiment. The process at S206 through S209 illustrated in FIG. 18 is substantially the same as the process at S106 through S109 illustrated in FIG. 15. The process at S211, S212, and S215 illustrated in FIG. 19 is substantially the same as the process at S111, S112, and S115 illustrated in FIG. 14.

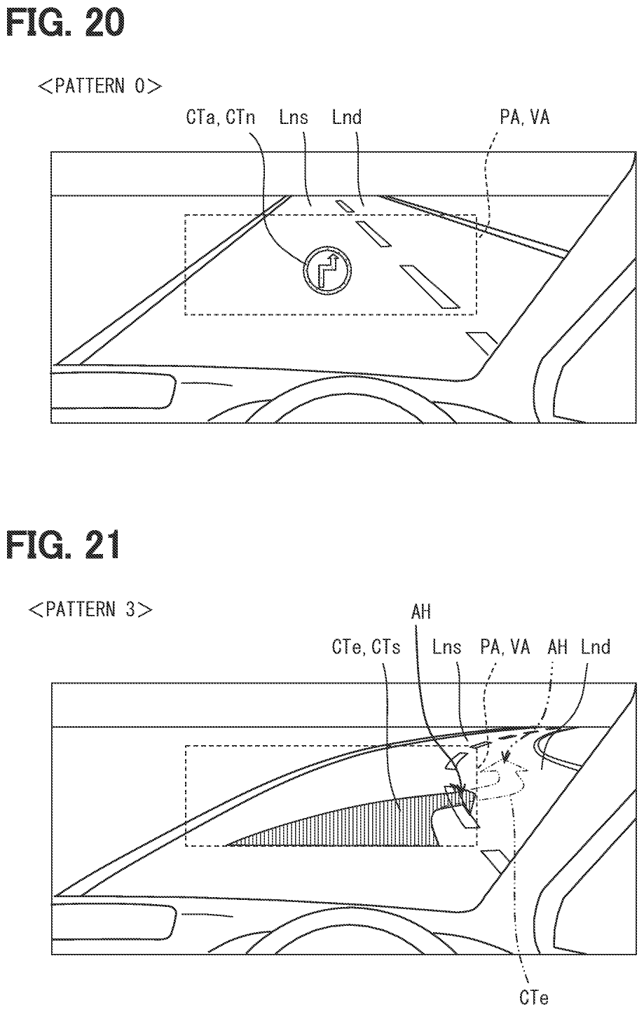

The display of pattern 0 illustrated in FIG. 20 starts based on an input of the on-operation on the turn signal switch 56 (see FIG. 3) as with the first embodiment (see S103 in FIG. 14). Also in the second embodiment, response notification content CTa displayed in pattern 0 is a non-superimposition content CTn independent of a superimposition target. Response notification content CTa is a display object that includes an arrow-shaped center image portion and an outer image portion. The arrow-shaped center image portion bends toward destination lane Lnd and indicates the travel direction (upward). The outer image portion circularly surrounds the arrow shape. Response notification content CTa is continuously displayed at a predetermined position in the angle of view VA from the beginning to the end of the display while maintaining a predetermined shape. For example, response notification content CTa is displayed approximately at the center of the angle of view VA (projection range PA) and is thereby superimposed on subject vehicle lane Lns (or destination lane Lnd) in the foreground.

The display generation unit 76 (see FIG. 3) selects the display of pattern 3 illustrated in FIG. 21 when the display of fulfillment notification content CTe (see the dash-dot-dot-dash line) in the reference shape allows point part AH to overreach the angle of view VA (see S210 in FIG. 18). Fulfillment notification content CTe of pattern 3 is displayed to superimpose on the road surface in the foreground and is transformed so that point part AH is positioned in the angle of view VA.

Specifically, fulfillment notification content CTe of pattern 3 provides superimposition content CTs in such a shape that the tip of fulfillment notification content CTe in the reference shape shrinks into the angle of view VA. Fulfillment notification content CTe extends point part AH to near the outer edge of the angle of view VA. Point part AH indicates the direction of destination lane Lnd. The superimposition target of fulfillment notification content CTe according to pattern 3 may include a slight portion of the road surface of destination lane Lnd or only the road surface of subject vehicle lane Lns.

Fulfillment notification content CTe in the reference shape signifies fulfillment notification content CTe displayed in pattern 1 (see FIG. 6). Namely, the reference shape of fulfillment notification content CTe corresponds to the shape of virtual object VO (see FIG. 4) viewed from eyepoint EP (see FIG. 2). More specifically, fulfillment notification content CTe in the reference shape is comparable to fulfillment notification content CTe in the mode where point part AH superimposed on the road surface of destination lane Lnd indicates the future travel direction of vehicle A. Meanwhile, the transformed fulfillment notification content CTe of pattern 3 is shaped to indicate the relative direction of destination lane Lnd.

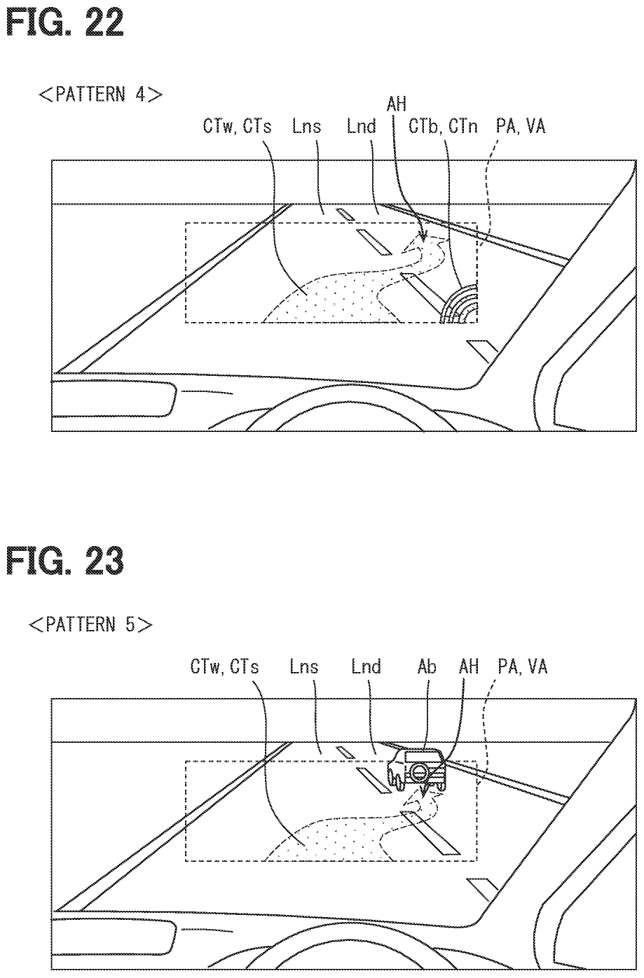

The display of pattern 4 illustrated in FIG. 22 is selected when the lane change remains in the standby state and another vehicle Ab (see FIG. 23) exists outside the angle of view VA (see S213 in FIG. 19). The display of pattern 4 superimposes standby notification content CTw in the reference shape and different vehicle notification icon CTb in the foreground.

Standby notification content CTw is superimposition content CTs that indicates the standby state of the lane change. Similar to fulfillment notification content CTe, standby notification content CTw is displayed to superimpose across both subject vehicle lane Lns and destination lane Lnd in the foreground. For example, standby notification content CTw is shaped in an arrow indicating an estimated trace on the assumption that another vehicle Ab does not exist. Point part AH of standby notification content CTw indicates the travel direction of the subject vehicle on destination lane Lnd. The shape of such standby notification content CTw is updated at a predetermined cycle according to the shape of the road surface as a superimposition target during the period in which the standby state is continuously determined to be valid. For example, the cycle of updating the shape of standby notification content CTw is set to be approximate to or longer than the update cycle (such as 10 ms) of scheduled travel trace PR (see FIG. 4). As a result, standby notification content CTw represents an estimated trace of vehicle A on the assumption that the execution state is activated to start the lane change.

Standby notification content CTw is displayed in a superimposing manner different from fulfillment notification content CTe. Specifically, standby notification content CTw is defined as a display object that changes at least the display color or the display brightness compared to fulfillment notification content CTe and uses a color lighter than that used for fulfillment notification content CTe. For example, the display of standby notification content CTw uses a higher intensity of display color than fulfillment notification content CTe and a lower display brightness than fulfillment notification content CTe. Furthermore, the outline of standby notification content CTw differs from the outline of fulfillment notification content CTe. For example, the outline of fulfillment notification content CTe is drawn as a solid line. The outline of standby notification content CTw is drawn as a broken line.

When the control transitions from the standby state (see S213 in FIG. 19) to the execution state (see S207 in FIG. 18), a wipe animation is displayed to change, for example, the display color of the arrow-shaped standby notification content CTw from the subject vehicle in the travel direction. Such an animation is used for the display transition from standby notification content CTw to fulfillment notification content CTe.

Similar to the first embodiment, different vehicle notification icon CTb is a non-superimposition content CTn that notifies the driver of the existence of another vehicle Ab causing the standby state. Different vehicle notification icon CTb according to the second embodiment is shaped in a ripple that propagates from a corner to the center of the angle of view VA (projection range PA). The display position of different vehicle notification icon CTb corresponds to another vehicle Ab relative to the subject vehicle. For example, when another vehicle Ab travels at the right rear-side of the subject vehicle, different vehicle notification icon CTb is displayed at the lower right one of the four corners of projection range PA. When another vehicle Ab travels at the right front-side of the subject vehicle, different vehicle notification icon CTb is displayed at the upper right corner of projection range PA.

The display of pattern 5 illustrated in FIG. 23 is selected when the lane change remains in the standby state and another vehicle Ab exists in the angle of view VA (see S214 in FIG. 19). The display of pattern 5 includes a transformed standby notification content CTw. Specifically, the standby notification content CTw is shaped so that the position of point part AH is moved behind another vehicle Ab based on standby notification content CTw (see FIG. 22) as the reference shape to avoid an overlap with another vehicle Ab visible through the angle of view VA (projection range PA). Pattern 5 also displays standby notification content CTw to superimpose across the road surfaces of subject vehicle lane Lns and destination lane Lnd. The shape of standby notification content CTw is updated at a predetermined cycle according to the shape of the road surface viewed from eyepoint EP (see FIG. 2) during the period in which the standby state is continuously determined to be valid.

According to the second embodiment described so far, point part AH of fulfillment notification content CTe in the reference shape may overreach the angle of view VA of the HUD 20. Then, fulfillment notification content CTe is transformed so that point part AH is positioned within the angle of view VA. The transformed fulfillment notification content CTe can use point part AH to continuously indicate destination lane Lnd as a destination of the lane change. As above, it is possible to provide the lane change fulfillment schedule in an easy-to-understand manner despite possible limitations on the angle of view VA of the HUD 20.

Also according to the second embodiment, the driver can recognize that the system has accepted input of the on-operation by viewing that the display of response notification content CTa starts based on the acquisition of the on-operation information. The driver can easily increase the feeling of reliability. Furthermore, it is possible to omit a process to identify superimposition targets by using response notification content CTa as non-superimposition content CTn. This makes it possible to start displaying response notification content CTa in quick response to the on-operation. As a result, the driver can feel improved operability.

### Third Embodiment

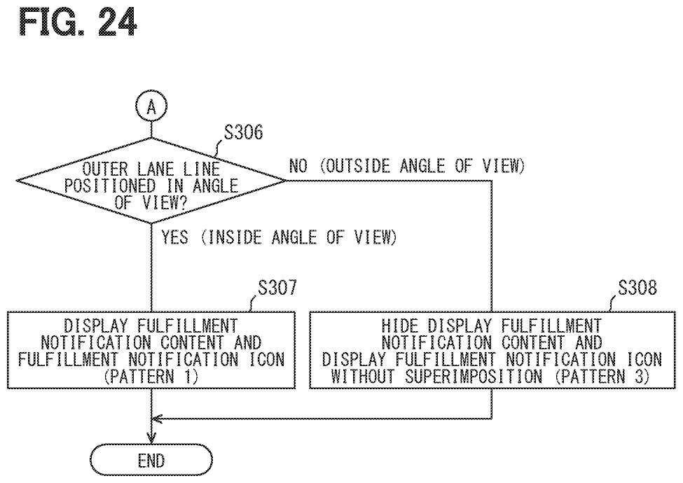

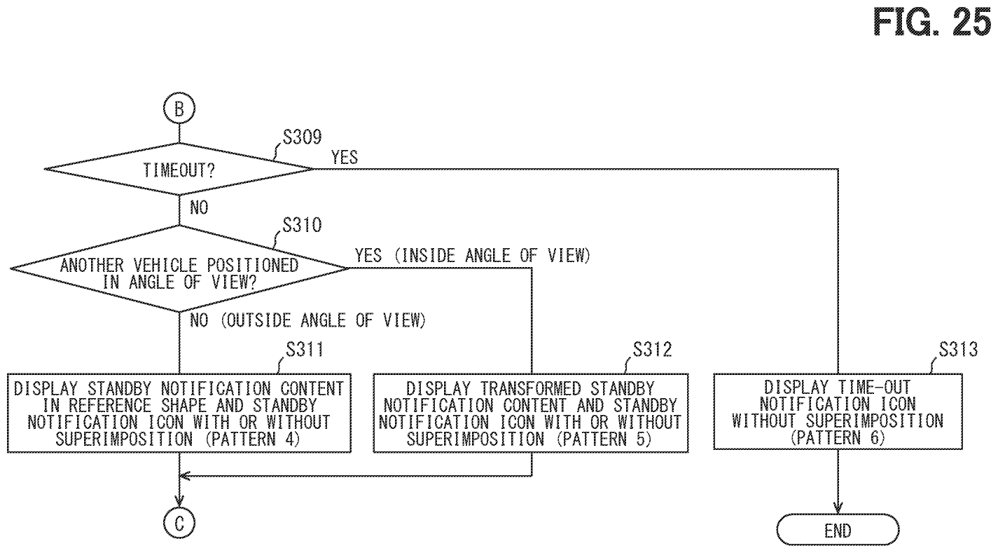

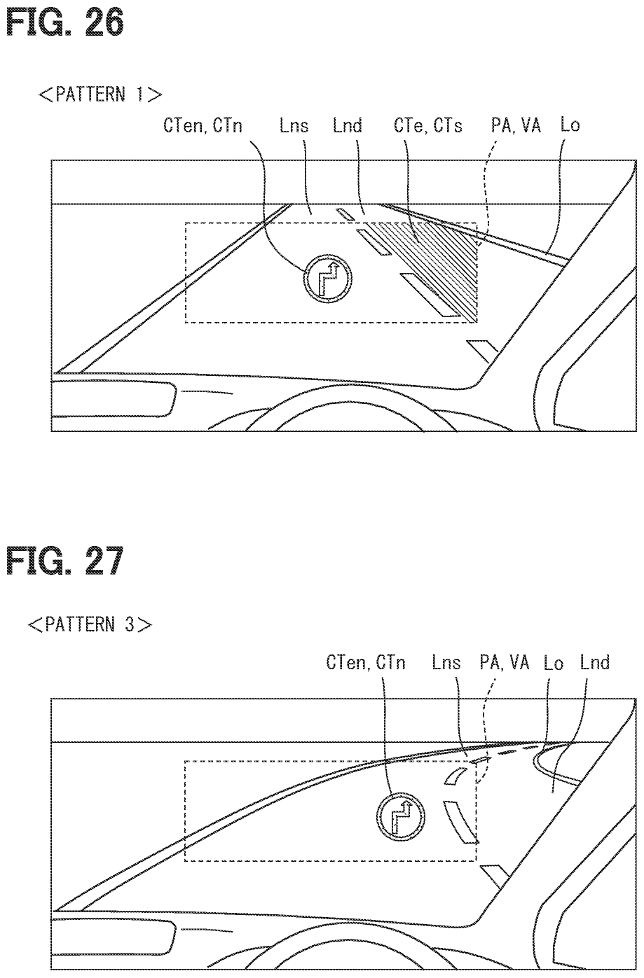

The third embodiment of the present disclosure illustrated in FIGS. 24 through 29 is another modification of the first embodiment. The third embodiment differs from the first embodiment in the overreach determination logic at S306 of the display control method illustrated in FIGS. 24 and 25. Moreover, the third embodiment differs from the first and second embodiments in the pattern displays based on S307, S308, S311, and S312. The description below explains in detail the display control method (see FIGS. 24 and 25) and the pattern displays (see FIGS. 26 through 29) according to the third embodiment in turn.

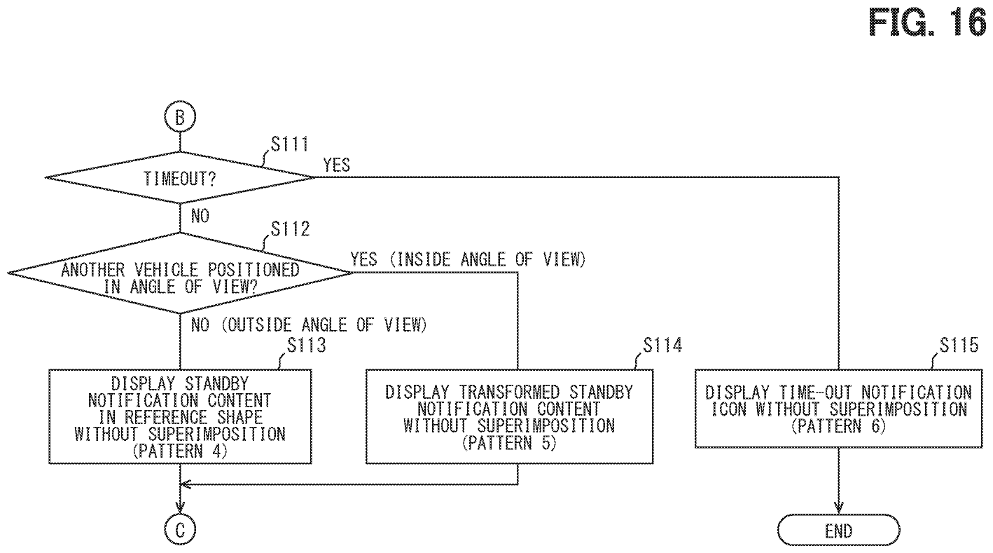

The displays of patterns 0 and 6 in the third embodiment are substantially the same as those in the second embodiment. The third embodiment excludes displays of patterns 2 and 7. The process at S309, S310, and S313 illustrated in FIG. 24 is substantially the same as the process at S111, S112, and S115 illustrated in FIG. 16.

As illustrated in FIGS. 24 and 25, the display generation unit 76 (see FIG. 3) performs the process at S306 to determine whether fulfillment notification content CTe overreaches the angle of view VA. At S306, the process recognizes relative positions of lane lines on both sides of destination lane Lnd as a destination of the lane change. Then, the process determines whether outer lane line Lo distant from vehicle A is positioned outside the angle of view VA, based on the simulation result of the display layout.

At S306, it may be determined that outer lane line Lo is positioned in the angle of view VA. Then, the process determines that fulfillment notification content CTe does not overreach, and proceeds to S307. At S307, the display of pattern 1 is generated. At S306, it may be determined that outer lane line Lo is positioned outside the angle of view VA. Then, the process determines that fulfillment notification content CTe overreaches, and proceeds to S308. At S308, the display of pattern 3 is generated.

The display of pattern 1 illustrated in FIG. 26 includes fulfillment notification content CTe in the reference shape and fulfillment notification icon CTen. Fulfillment notification content CTe is superimposition content CTs that assumes the road surface in the foreground to be a superimposition target and indicates the lane change fulfillment schedule. Unlike the first embodiment, fulfillment notification content CTe according to the third embodiment is not shaped in an arrow.

Fulfillment notification content CTe is displayed to uniformly fill the road surface of destination lane Lnd, making it possible to emphasize destination lane Lnd and notify the driver of the execution state of the lane change. Fulfillment notification content CTe may be displayed in a blinking state, for example. The display shape of fulfillment notification content CTe is updated in conformity to the road surface shape viewed from eyepoint EP (see FIG. 2) until the completion of the lane change control to such an extent that the LCA control unit 51 (see FIG. 3) updates scheduled travel trace PR (see FIG. 4).

Fulfillment notification icon CTen is a non-superimposition content CTn independent of a superimposition target. Fulfillment notification icon CTen is displayed approximately at the center of the angle of view VA (projection range PA) and is mainly superimposed on subject vehicle lane Lns. Like fulfillment notification content CTe, fulfillment notification icon CTen indicates the execution state of the lane change. As with the first embodiment, fulfillment notification icon CTen is a display object including an arrow-shaped center image portion and a circular outer image portion. Fulfillment notification icon CTen is displayed in substantially the same display color and display brightness as the adjacent fulfillment notification content CTe. Fulfillment notification icon CTen is continuously displayed while maintaining the specified shape until the completion of the lane change control. The display position of fulfillment notification icon CTen may be shifted vertically according to the position to start the lane change. Fulfillment notification icon CTen may be blinked as with fulfillment notification content CTe.

Fulfillment notification content CTe (see FIG. 26) is invisible in the display of pattern 3 illustrated in FIG. 27. As a result, the display of pattern 3 includes fulfillment notification icon CTen that is substantially the same as that displayed in pattern 1. In other words, pattern 3 displays only non-superimposition content CTn. For example, the display position of fulfillment notification icon CTen is shifted to destination lane Lnd from the center of the angle of view VA (projection range PA).

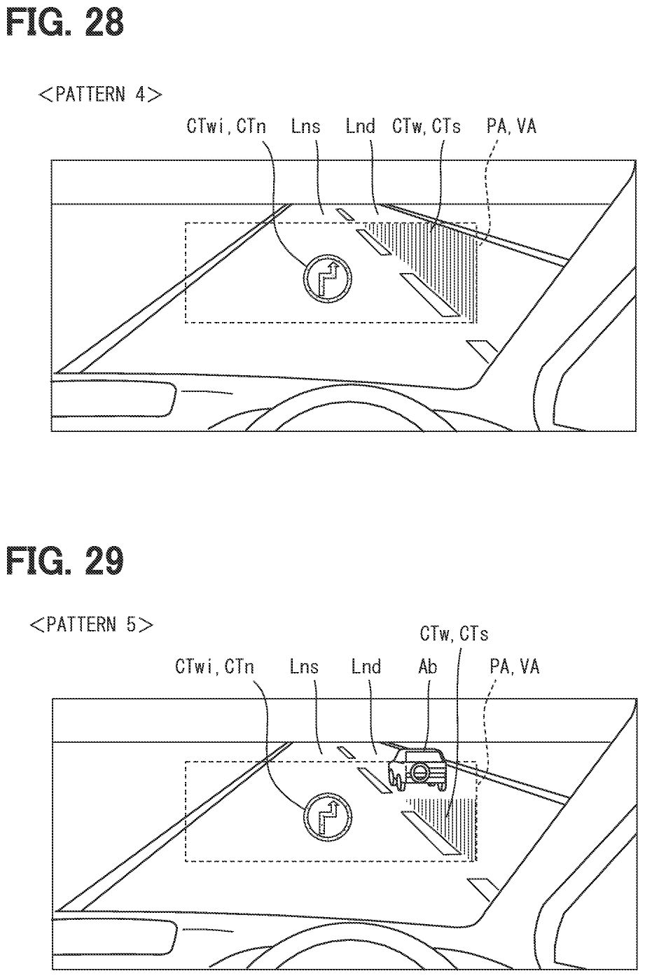

The display of pattern 4 illustrated in FIG. 28 includes standby notification content CTw in the reference shape and standby notification icon CTwi (see S311 in FIG. 25). Standby notification content CTw represents that the road surface of destination lane Lnd is defined as a superimposition target and the fulfillment schedule of the lane change made by the LCA control unit 51 (see FIG. 3) remains in the standby state. Standby notification content CTw is a superimposition content CTs that is displayed on the road surface of destination lane Lnd in a superimposing manner different from fulfillment notification content CTe (see FIG. 26).

Standby notification content CTw is displayed in a display color and display brightness different from fulfillment notification content CTe. For example, standby notification content CTw may be displayed in a display color such as yellow or amber to promote awareness. The display shape of standby notification content CTw is updated according to the shape of the road surface viewed from eyepoint EP (see FIG. 2) during the period in which the standby state is continuously determined to be valid.

For example, standby notification content CTw notifies the driver that the move to destination lane Lnd is inhibited by filling the road surface of destination lane Lnd in a display color to promote awareness. Alternatively, standby notification content CTw may notify the driver that an immediate move to destination lane Lnd is impossible by displaying the road surface of destination lane Lnd so that it seemingly slopes toward subject vehicle lane Lns.

Standby notification icon CTwi is a non-superimposition content CTn independent of a superimposition target. Standby notification icon CTwi has substantially the same shape as fulfillment notification icon CTen (see FIG. 26) and is displayed approximately at the center of the angle of view VA (projection range PA). Standby notification icon CTwi, in combination with standby notification content CTw, indicates that the instruction to perform the lane change is effective but it is difficult to immediately perform the same. Standby notification icon CTwi may be displayed in substantially the same display color and display brightness as fulfillment notification icon CTen or standby notification content CTw. Standby notification icon CTwi is continuously displayed while maintaining the predetermined shape and display position during the period in which the standby state is continuously determined to be valid.

The display of pattern 5 illustrated in FIG. 29 includes standby notification icon CTwi and transformed standby notification content CTw (see S312 in FIG. 25). Standby notification icon CTwi in pattern 5 is substantially the same as standby notification icon CTwi in pattern 4. However, standby notification content CTw is shaped by vertically reducing standby notification content CTw of pattern 4 (see FIG. 28) in the reference shape to behind another vehicle Ab so as not to interfere with the visual recognition of another vehicle Ab.

The third embodiment described so far displays the contents indicating the fulfillment schedule of the lane change made by the LCA control unit 51. The contents include not only fulfillment notification content CTe superimposed on the road surface, but also fulfillment notification icon CTen independent of a superimposition target. Fulfillment notification icon CTen as non-superimposition content CTn can continuously indicate the lane change fulfillment schedule without overreaching the angle of view VA. Fulfillment notification content CTe is hidden when overreaching the angle of view VA, making it difficult to interfere with the visual recognition of fulfillment notification icon CTen. As above, it is possible to provide the lane change fulfillment schedule in an easy-to-understand manner despite possible limitations on the angle of view VA of the HUD 20.

Moreover, according to the third embodiment, the display generation unit 76 determines that fulfillment notification content CTe overreaches the angle of view VA when outer lane line Lo overreaches the angle of view VA. Outer lane line Lo is one of the lane lines on both sides of destination lane Lnd and is distant from vehicle A. As above, the display generation unit 76 can determine whether a scene causes standby notification content CTw to overreach, at a relatively reduced calculation load. As a result, it is possible to more easily ensure the convenience of providing the information indicating the lane change fulfillment schedule.

### Fourth Embodiment

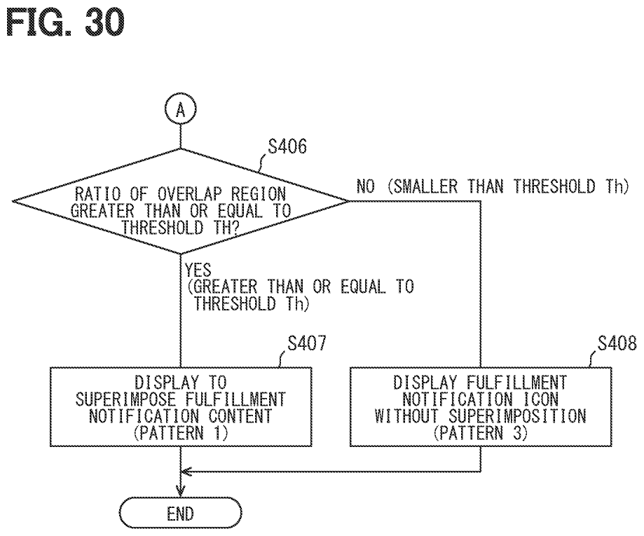

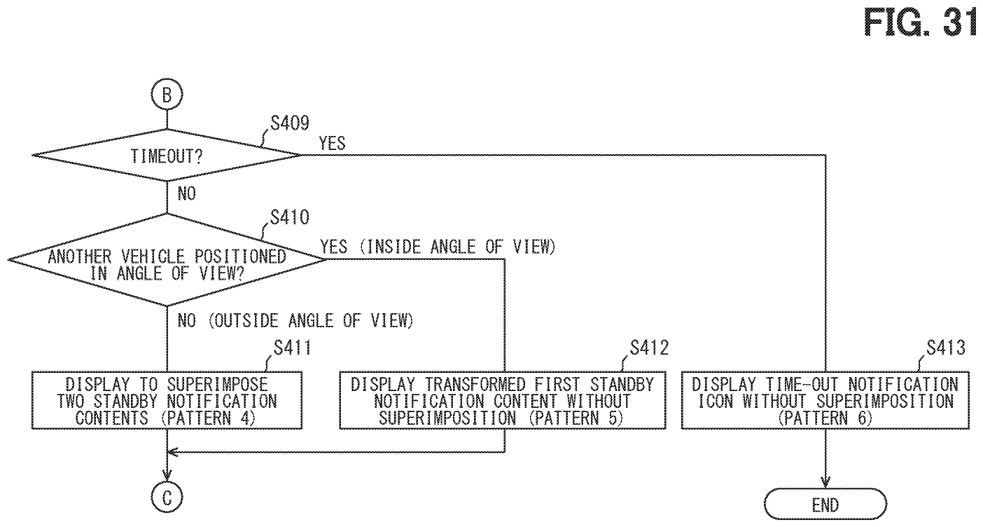

The fourth embodiment of the present disclosure illustrated in FIGS. 30 through 34 is still another modification of the first embodiment. The fourth embodiment differs from the above-described embodiments in the overreach determination logic at S406 of the display control method illustrated in FIGS. 30 and 31. Moreover, the fourth embodiment differs from the above-described embodiments in the pattern displays based on S407, S411, and S412. The description below explains in detail the display control method (see FIGS. 30 and 31) and the pattern displays (see FIGS. 32 through 34) according to the fourth embodiment in turn.

The displays of patterns 0 and 6 in the fourth embodiment are substantially the same as those in the first embodiment. The display of pattern 3 according to the fourth embodiment is the same as that of the third embodiment. The process at S408 illustrated in FIG. 30 and S409, S410, and S413 illustrated in FIG. 31 is substantially the same as the process at S308 illustrated in FIG. 24 and S309, S310, and S313 illustrated in FIG. 25.

As illustrated in FIGS. 30 and 31, the display generation unit 76 (see FIG. 3) performs the process at S406 to determine whether fulfillment notification content CTe overreaches the angle of view VA. At S406, the process simulates the display layout to calculate a dimensional ratio of overlap region Aol (see the range indicated by the dash-dot-dot-dash line in FIG. 32) in the entire region of the angle of view VA. Overlap region Aol overlaps destination lane Lnd as a destination of the lane change. The process determines whether the dimensional ratio of overlap region Aol exceeds a predetermined threshold th.

At S406, it may be determined that the dimensional ratio of overlap region Aol is greater than or equal to threshold th. Then, the process determines that fulfillment notification content CTe does not overreach, and proceeds to S407. At S407, the display of pattern 1 is generated. At S406, it may be determined that the dimensional ratio of overlap region Aol is smaller than threshold th. Then, the process determines that fulfillment notification content CTe overreaches, and proceeds to S408. At S408, the process generates the display of pattern 3 (see FIG. 8) that provides fulfillment notification icon CTen instead of fulfillment notification content CTe.

The display of pattern 1 illustrated in FIG. 32 includes fulfillment notification content CTe. Unlike the first embodiment, fulfillment notification content CTe according to the fourth embodiment is not shaped in an arrow. Fulfillment notification content CTe is a belt-like superimposition content CTs that represents an estimated trace of vehicle A and extends along scheduled travel trace PR generated by the LCA control unit 51. The tip part of fulfillment notification content CTe is superimposed on the road surface of destination lane Lnd. The base part of fulfillment notification content CTe is superimposed on the road surface of subject vehicle lane Lns.

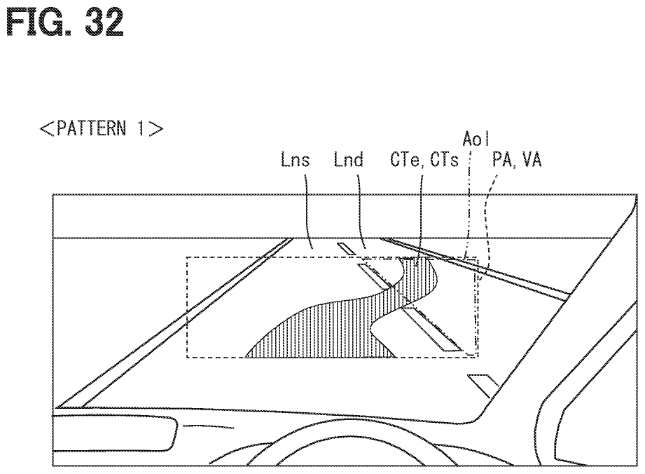

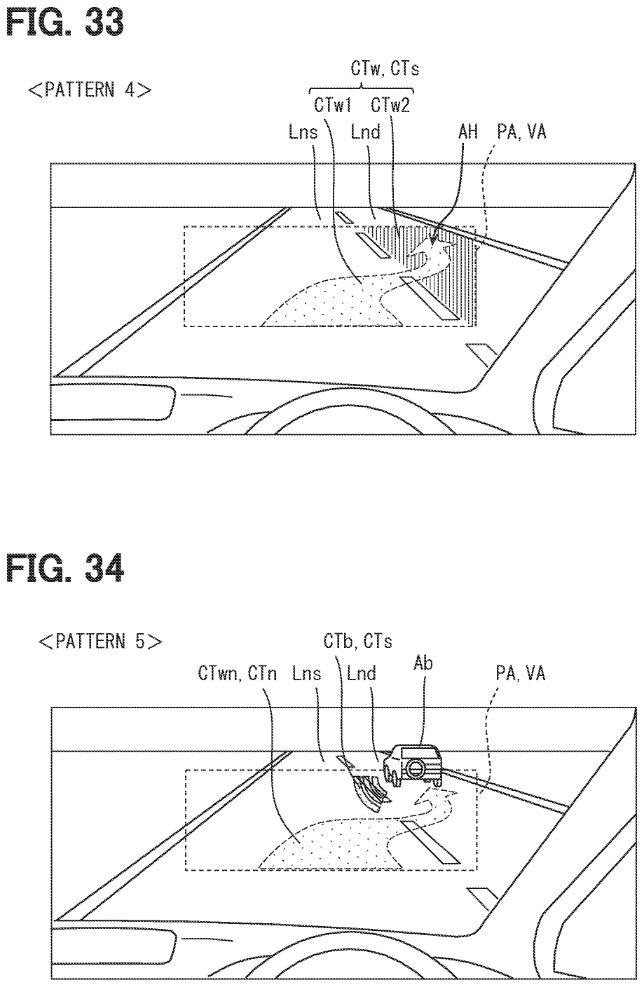

The display of pattern 4 illustrated in FIG. 33 contains two standby notification contents CTw (see S411 in FIG. 31). The two standby notification contents CTw are superimposition contents CTs both associated with the road surface in the foreground as a superimposition target and are displayed in a mode different from fulfillment notification content CTe in pattern 1 (see FIG. 32). The two standby notification contents CTw indicate that the lane change scheduled by the LCA control unit 51 (see FIG. 3) remains in the standby state. In the following description, one of the two standby notification contents CTw is referred to as “first standby notification content CTw1” and the other is referred to as “second standby notification content CTw2.”

The first standby notification content CTw1 is substantially the same as standby notification content CTw (see FIG. 22) according to the second embodiment. The first standby notification content CTw1 is shaped in an arrow and is displayed to superimpose across both road surfaces of subject vehicle lane Lns and destination lane Lnd to indicate an estimated trace on the assumption that another vehicle Ab does not exist. The first standby notification content CTw1 differs from fulfillment notification content CTe (see FIG. 32) in the mode of including point part AH.

The second standby notification content CTw2 is substantially the same as standby notification content CTw (see FIG. 28) according to the third embodiment and displays the road surface of destination lane Lnd so that it seemingly slopes toward subject vehicle lane Lns. The first standby notification content CTw1 is superimposed on the second standby notification content CTw2. The second standby notification content CTw2 is displayed in a display color and display brightness different from that of the first standby notification content CTw1 to mark a clear distinction from the first standby notification content CTw1.

When the control transitions from the standby state to the execution state, the display generation unit 76 displays a wipe animation that changes the display color and outline of the first standby notification content CTw1 from the subject vehicle in the travel direction. Such an animation changes the first standby notification content CTw1 to fulfillment notification content CTe while allowing point part AH to fade away. The display generation unit 76 terminates the display of the second standby notification content CTw2 in parallel with a change in the display of the first standby notification content CTw1.

The display of pattern 5 illustrated in FIG. 34 includes standby notification content CTwn and different vehicle notification icon CTb. Like standby notification content CTwn according to the first embodiment (see FIG. 10), standby notification content CTwn is a non-superimposition content CTn that is shaped in an arrow and extends from subject vehicle lane Lns to destination lane Lnd. Unlike the first embodiment, standby notification content CTwn is displayed to seemingly stick to the road surface. Standby notification content CTwn is placed in a mode associated with fulfillment notification content CTe in pattern 1 (see FIG. 32). Specifically, the display shape extends on the road surface to indicate an estimated trace of vehicle A similar to fulfillment notification content CTe. Standby notification content CTwn allows point part AH to be positioned behind another vehicle Ab and is accordingly reshaped to avoid an overlap with another vehicle Ab in the foreground. Different vehicle notification icon CTb is substantially the same as different vehicle notification icon CTb displayed in pattern 5 (see FIG. 10) according to the first embodiment.

Similar to the first embodiment, the fourth embodiment described so far also displays fulfillment notification icon CTen as a non-superimposition content CTn when fulfillment notification content CTe overreaches the angle of view VA. As a result, the same effect as that of the first embodiment can be produced. It is possible to provide the lane change fulfillment schedule in an easy-to-understand manner despite possible limitations on the angle of view VA of the HUD 20.

Moreover, the fourth embodiment determines that fulfillment notification content CTe overreaches the angle of view VA when the ratio of overlap region Aol exceeds threshold th. Also through the use of the determination logic, the display generation unit 76 can determine whether a scene causes standby notification content CTw to overreach, at a relatively reduced calculation load. As a result, it is possible to more easily ensure the convenience of providing the information indicating the lane change fulfillment schedule. In the fourth embodiment, threshold th used for the overreach determination is comparable to a “predetermined value.”

### Fifth Embodiment

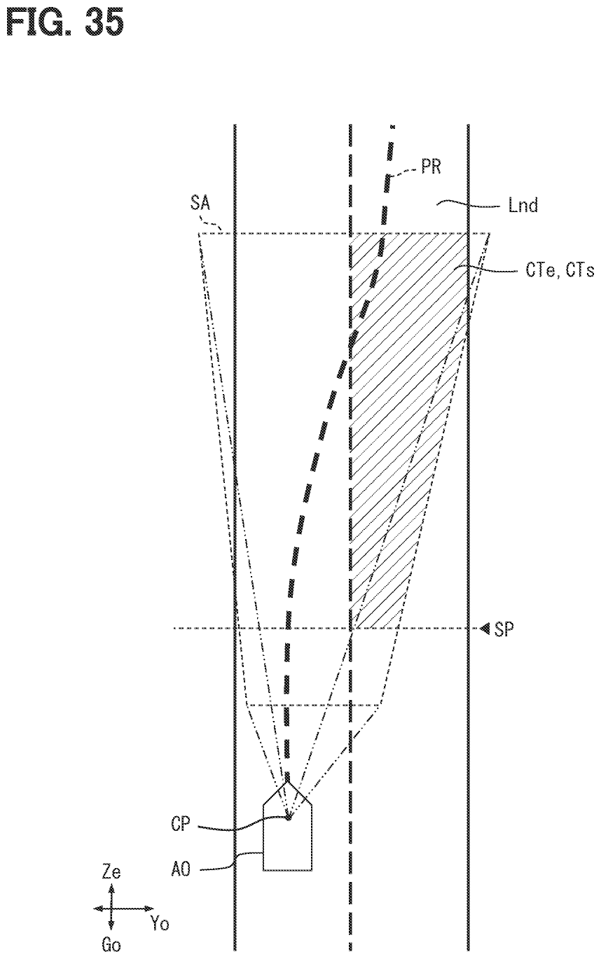

The fifth embodiment of the present disclosure illustrated in FIGS. 35 through 40 is a modification of the fourth embodiment. The fifth embodiment differs from the fourth embodiment in displays of patterns 0, 1, 4, and 5. Specifically, according to the fifth embodiment, superimposition content CTs is displayed in a superimposing manner so as to fill the road surface of destination lane Lnd and is used to notify operation states of the LCA function. Displays of patterns 3 and 6 are substantially the same as those of the fourth embodiment. The description below explains in detail the pattern displays according to the fifth embodiment in turn.

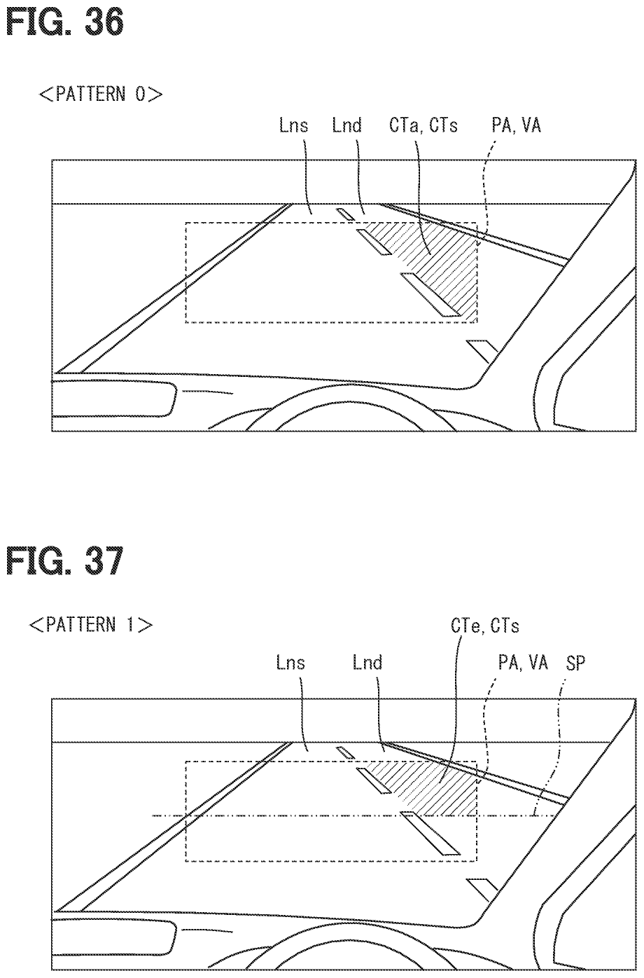

Similar to the above-described embodiments, the display of pattern 0 illustrated in FIG. 36 includes response notification content CTa. Response notification content CTa is a superimposition content CTs superimposed on the road surface of destination lane Lnd. Based on detection information resulting from detecting the road surface range of destination lane Lnd, response notification content CTa is displayed to superimpose on the entire range of overlap between the road surface of destination lane Lnd and the angle of view VA.

The display of pattern 1 illustrated in FIG. 37 includes fulfillment notification content CTe in the mode associated with response notification content CTa. Fulfillment notification content CTe is displayed in substantially the same display color and display brightness as response notification content CTa. Fulfillment notification content CTe is displayed to superimpose on a range of the road surface of destination lane Lnd ahead, Ze (see FIG. 35), from movement start point SP that starts the move to destination lane Lnd. The movement start point SP causes the transition from LTA control to LCA control and induces a sideways acceleration for the lane change. For example, when the display transitions from response notification content CTa to fulfillment notification content CTe, an animation is displayed to narrow the filled range toward the front Ze.

As above, there may be a case where the driver performs an on-operation on the turn signal switch 56 (see FIG. 1), and then the LCA control unit 51 (see FIG. 1) immediately activates the move to destination lane Lnd (see FIG. 17). In this case, as illustrated in FIG. 38, movement start point SP is set very close to vehicle A and is therefore positioned outside the angle of view VA. Therefore, fulfillment notification content CTe is superimposed on the road surface (see the dotted range) ahead (Ze) of movement start point SP in substantially the same mode as response notification content CTa. In this case, it is impossible to distinguish between the display of pattern 0 and the display of pattern 1.

As a solution, the fifth embodiment displays pattern 1 that blinks fulfillment notification content CTe at a predetermined cycle when vehicle A starts a sideways movement immediately after the on-operation is input to the turn signal switch 56. The blinking display of fulfillment notification content CTe is controlled to be synchronized with the blinking cycle of a turn signal lamp (directional signal indicator) of vehicle A, for example. The blinking display enables the distinction between the displays in patterns 0 and 1.

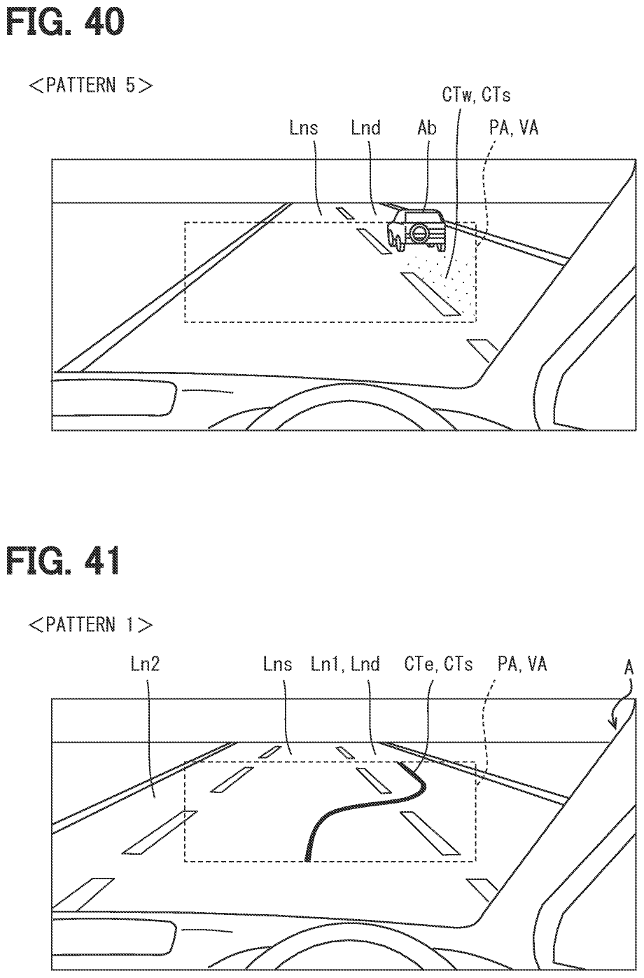

The display of pattern 4 illustrated in FIG. 39 includes standby notification content CTw and different vehicle notification icon CTb. Like response notification content CTa, standby notification content CTw is displayed to superimpose on the entire range of overlap between the road surface of destination lane Lnd and the angle of view VA. Standby notification content CTw is displayed in a superimposing manner different from response notification content CTa and fulfillment notification content CTe. Specifically, standby notification content CTw uses at least the display color or the display brightness changed from the contents CTa and CTe. For example, standby notification content CTw is displayed in a display color less noticeable than the contents CTa and CTe. Similar to the second embodiment (see FIG. 22), different vehicle notification icon CTb is a non-superimposition content CTn that notifies the driver of the existence of another vehicle Ab (see FIG. 40) causing the standby state. Different vehicle notification icon CTb is displayed at the lower right corner of the angle of view VA, for example.

The display of pattern 5 illustrated in FIG. 40 includes a transformed standby notification content CTw. Standby notification content CTw in pattern 5 is shaped by vertically reducing standby notification content CTw in pattern 4 to behind another vehicle Ab so as not to interfere with the visual recognition of another vehicle Ab. Standby notification content CTw in pattern 5 may use substantially the same display color and display brightness as those in pattern 4.

According to the fifth embodiment described so far, pattern 1 displays fulfillment notification content CTe to superimpose on an entire range of the road surface of destination lane Lnd ahead of movement start point SP when the lane change remains in the execution state. Therefore, fulfillment notification content CTe can provide the driver with the lane change fulfillment schedule, specifically, the timing to start moving sideways in an easy-to-understand manner.

The fifth embodiment uses pattern 0 before the transition of the lane change to the execution state to display response notification content CTa in the mode associated with fulfillment notification content CTe to superimpose on substantially the entire road surface of destination lane Lnd included in the angle of view VA. Response notification content CTa can be displayed as superimposition content CTs in a highly noticeable mode. The driver can therefore more easily recognize that the system has normally accepted the input on-operation. In the fifth embodiment, response notification content CTa is comparable to a “pre-notification content.”

### Other Embodiments

While there have been described embodiments of the present disclosure, the disclosure should not be understood exclusively in terms of the above-mentioned embodiments but may be applicable to various embodiments and combinations within the spirit and scope of the disclosure.

According to a first modification of the third embodiment illustrated in FIG. 41, the display generation unit uses an overreach determination logic different from the determination logic of the third embodiment (see S306 in FIG. 24). The display generation unit according to the first modification determines whether fulfillment notification content CTe overreaches the angle of view VA, based on the movement direction of vehicle A during the lane change.

In detail, the driver's seat and the passenger seat are placed in a horizontal direction of vehicle A. For example, the driver's seat is located to the right of the passenger seat in vehicle A with the steering wheel on the right side. Therefore, the right front-side is wider than the left front-side in the front superimposition range visible through projection range PA in front of the driver. Suppose right-side adjacent lane Ln1 on the driver's seat side is destination lane Lnd in the lane change. Then, the display generation unit assumes that fulfillment notification content CTe does not overreach the angle of view VA. Suppose left-side adjacent lane Ln2 on the passenger seat side is the destination lane in the lane change. Then, the display generation unit assumes that fulfillment notification content CTe overreaches the angle of view VA. Such a determination can significantly reduce arithmetic resources required for the overreach determination.

On a left-hand drive vehicle, the display generation unit assumes that the fulfillment notification content does not overreach the angle of view when the left-side adjacent lane corresponds to the destination lane. The display generation unit assumes that the fulfillment notification content overreaches the angle of view when the right-side adjacent lane corresponds to the destination lane in the lane change.

Fulfillment notification content CTe used to display pattern 1 according to the first modification is provided as a superimposition content CTs indicating an estimated trace of vehicle A through the use of a shape that extends in a curved line. Fulfillment notification content CTe is drawn along scheduled travel trace PR (see FIG. 4) and is displayed to superimpose across both road surfaces of subject vehicle lane Lns and destination lane Lnd.

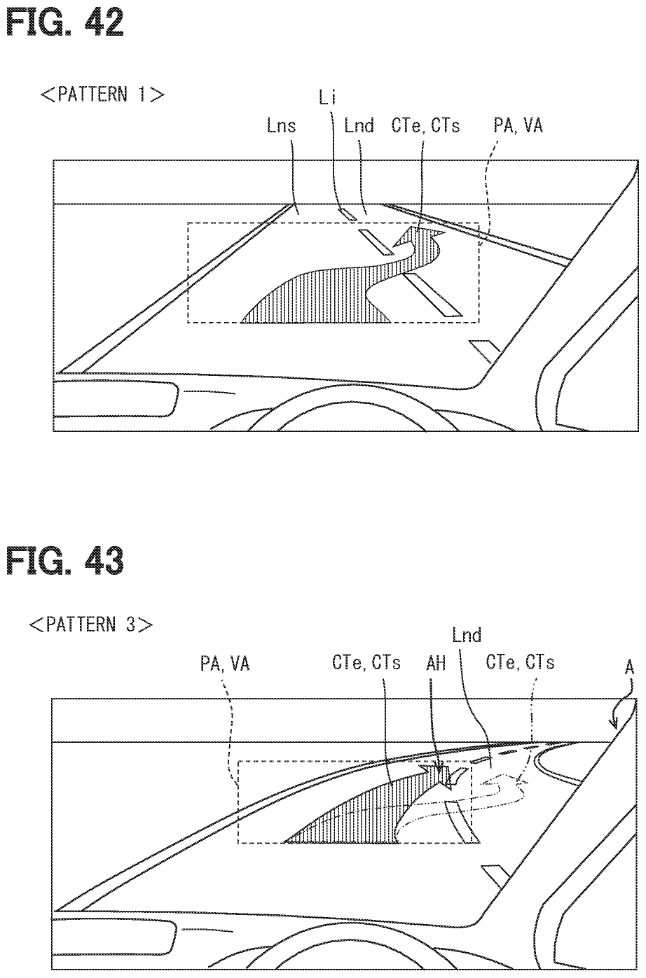

Like the first modification, according to a second modification of the above-described embodiment illustrated in FIG. 42, the display generation unit uses an overreach determination logic different from the above-described embodiment. The display generation unit according to the second modification determines that fulfillment notification content CTe overreaches the angle of view VA when inner lane line Li between subject vehicle lane Lns and destination lane Lnd is positioned outside the angle of view VA. Inner lane line Li is one of the lane lines on both sides of destination lane Lnd and is close to the vehicle.

The display generation unit according to a third modification of the above-described embodiment determines that the fulfillment notification content overreaches the angle of view when any one of a curve curvature, a slope, and a vehicle speed exceeds a threshold value corresponding to each value. The display generation unit according to a fourth modification of the above-described embodiment determines whether fulfillment notification content CTe overreaches the angle of view VA by using a function that includes the curve curvature, the slope, and the vehicle speed as parameters. The display generation unit according to a fifth modification calculates an actual road surface area of the destination lane included in the angle of view VA and determines that the fulfillment notification content overreaches the angle of view when the road surface area is smaller than a predetermined value. Furthermore, it may be determined whether fulfillment notification content CTe overreaches, based on whether the main part other than point part AH is positioned in the angle of view VA. As above, the specific overreach determination logic may be changed as appropriate.

According to a sixth modification of the second embodiment illustrated in FIG. 43, the shape of fulfillment notification content CTe included in the display of pattern 3 differs from the second embodiment. According to the sixth modification, transformed fulfillment notification content CTe allows point part AH to indicate the travel direction of vehicle A. At this time, the direction indicated by point part AH does not differ from the movement direction in the lane change. Fulfillment notification content CTe enables a mode that indicates the completion point of the lane change on destination lane Lnd.

According to a seventh modification of the third embodiment, the fulfillment notification icon included in the displays of patterns 1 and 3 is displayed as a superimposition content to be superimposed on the road surface in the foreground. The fulfillment notification icon according to the seventh modification provides a superimposition target corresponding to the position to start steering control for the lane change on the road surface of the subject vehicle lane. Therefore, the fulfillment notification icon can provide the driver with the position to induce a sideways acceleration.

An eighth modification of the above-described embodiment does not transform the standby notification content to a shape that does not overlap the risk target. When another vehicle exists in the angle of view, the eighth modification stops providing standby notification content CTw (see FIGS. 10 and 23, for example) indicating an estimated trace in the display of pattern 5.

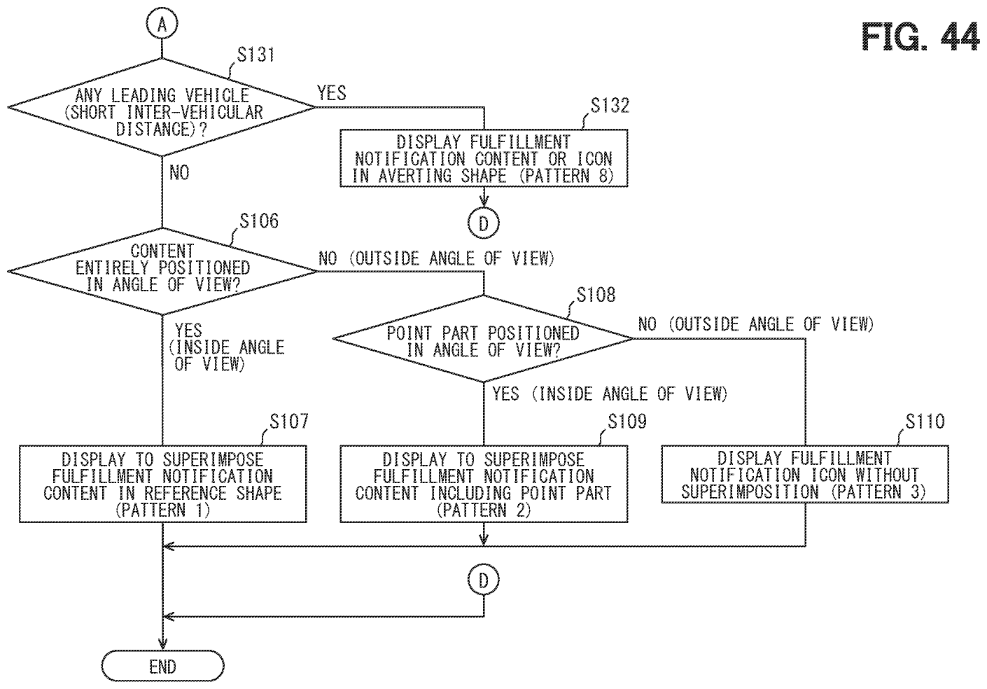

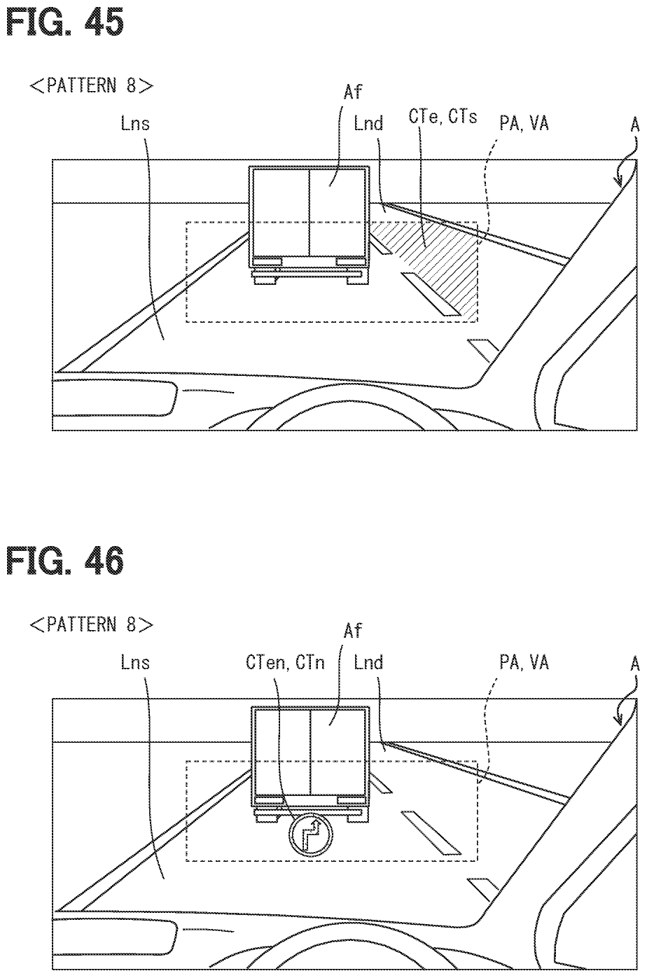

According to a ninth modification of the first embodiment illustrated in FIGS. 44 and 45, the mode of fulfillment notification content CTe is changed depending on the presence or absence of leading vehicle Af. Specifically, it may be determined that the lane change remains in the execution state (S105: YES in FIG. 14). Then, it is determined whether there is leading vehicle Af traveling subject vehicle lane Lns (S131 in FIG. 44). It may be determined that leading vehicle Af exists within a distance visible in the angle of view VA (S131: YES in FIG. 44). Then, as the display of “pattern 8,” the display generation unit displays fulfillment notification content CTe in an averting shape to avert leading vehicle Af (S132 in FIG. 44). The ninth modification displays superimposition content CTs to fill the entire road surface of destination lane Lnd as fulfillment notification content CTe in the averting shape instead of the arrow-shaped fulfillment notification content CTe (see FIG. 6).

A tenth modification of the first embodiment illustrated in FIGS. 44 and 46 switches contents based on the ACC function setting instead of determining the presence or absence of leading vehicle Af. In detail, the vehicle information acquisition unit acquires the control information about at least the inter-vehicle distance setting or the speed setting in the ACC function. The display generation unit determines whether the inter-vehicle distance control is provided based on the control information of the ACC function or based on the setting of “short” inter-vehicular distance. It may be determined that the ACC function setting is a predetermined condition (S105: YES in FIG. 44). Then, the display generation unit displays notification icon CTen (S132 in FIG. 44) as the display of “pattern 8” instead of the arrow-shaped fulfillment notification content CTe (see FIG. 6). Fulfillment notification icon CTen is displayed near the bottom edge of the angle of view VA, in other words, behind leading vehicle Af, to decrease an overlap with leading vehicle Af in the foreground.

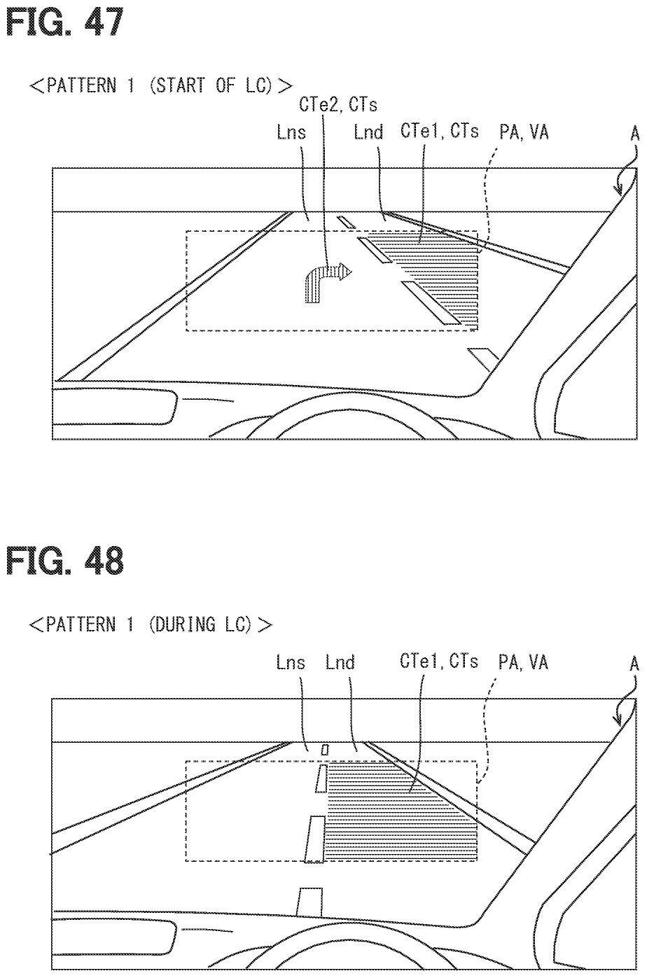

FIGS. 47 through 51 illustrate eleventh and twelfth modifications as modifications of the fifth embodiment. Like the fifth embodiment, the eleventh and twelfth modifications use pattern 0 to display response notification content CTa that fills the road surface of destination lane Lnd (see FIG. 36). Response notification content CTa may blink. According to the eleventh and twelfth modifications, however, pattern 1 displays superimposition content CTs different from fulfillment notification content CTe (see FIG. 37) according to the fifth embodiment.

Specifically, the display of pattern 1 according to the eleventh modification illustrated in FIGS. 47 and 48 includes the first fulfillment notification content CTe1 and the second fulfillment notification content CTe2. The first fulfillment notification content CTe1 is a superimposition content CTs superimposed on the entire road surface of destination lane Lnd similar to response notification content CTa (see FIG. 36). The first fulfillment notification content CTe1 differs from response notification content CTa in at least one of different display colors, display brightness, and the presence or absence of blinking. As a result, the first fulfillment notification content CTe1 is presented to be distinguishable from response notification content CTa. When the first fulfillment notification content CTe1 is blinked, the blinking cycle may be synchronized with the turn signal lamp. The display area of the first fulfillment notification content CTe1 is expanded according to the sideways movement of the subject vehicle due to the lane change (see FIG. 48).

The second fulfillment notification content CTe2 is an arrow-shaped superimposition content CTs superimposed on only the road surface of subject vehicle lane Lns. For example, the second fulfillment notification content CTe2 is displayed in substantially the same display color and display brightness as the first fulfillment notification content CTe1. The second fulfillment notification content CTe2 is additionally displayed due to the transition of the lane change to the execution state. The second fulfillment notification content CTe2 is hidden when movement start point SP is passed after a predetermined time from the start of the lane change or when the subject vehicle crosses the lane line (see FIG. 48).

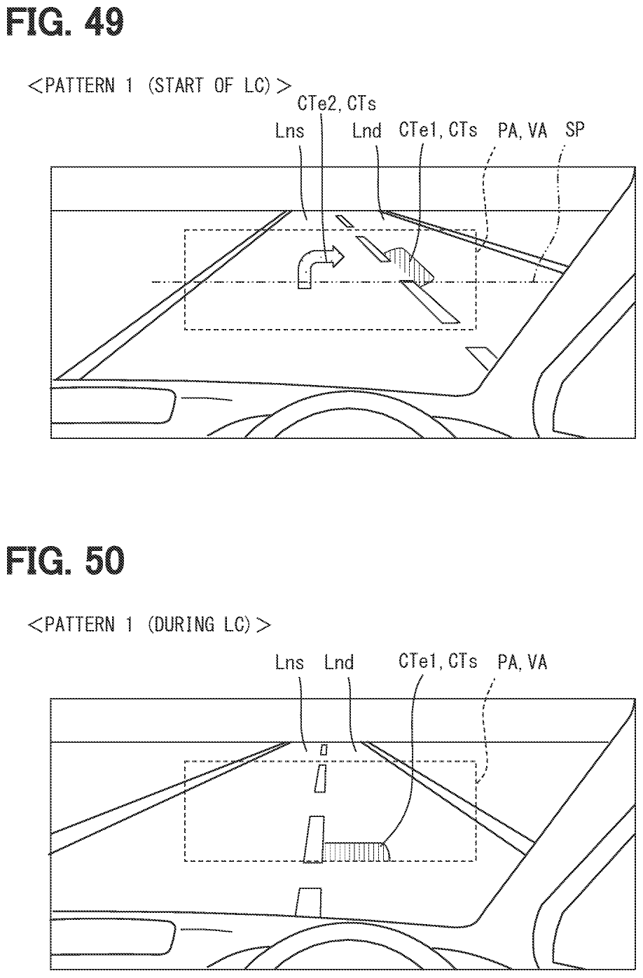

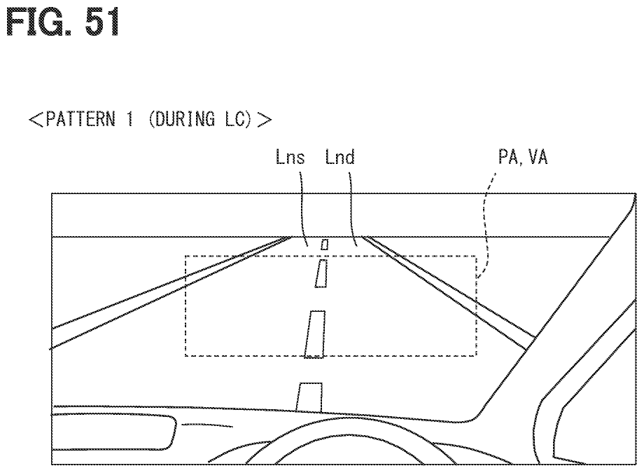

The display of pattern 1 according to the twelfth modification illustrated in FIGS. 49 through 51 includes the first fulfillment notification content CTe1 superimposed on a part of the road surface of destination lane Lnd in addition to the second fulfillment notification content CTe2 substantially the same as the eleventh modification. The first fulfillment notification content CTe1 is a superimposition content CTs indicating movement start point SP (see FIG. 35) of the subject vehicle. The first fulfillment notification content CTe1 has a display size similar to the subject vehicle size (approximately 4 through 5 meters long) and is superimposed on the road surface of destination lane Lnd. The first fulfillment notification content CTe1 is displayed until it overreaches the angle of view VA while vehicle A travels (see FIG. 50). Like the eleventh modification, the second fulfillment notification content CTe2 is hidden when movement start point SP is passed after a predetermined time from the start of the lane change or when the subject vehicle crosses the lane line, for example (see FIG. 50). Both the first fulfillment notification content CTe1 and the second fulfillment notification content CTe2 may be hidden after a predetermined time from the start of the lane change or when the subject vehicle crosses the lane line (see FIG. 51).

For example, the lane change in process may be canceled when another vehicle approaches from behind on destination lane Lnd. When the lane change once started is canceled, an LCA function provides control (cancellation control) to return to the lane (most recent subject vehicle lane Lns) from which the vehicle moved. A scene to provide the LCA cancellation control displays contents to cancel the lane change such as a superimposition content to fill the most recent subject vehicle lane Lns (left lane in FIG. 50) and a superimposition content including an arrow shape to indicate scheduled travel trace PR to return to the most recent subject vehicle lane Lns, for example. The content to cancel the lane change is hidden after the subject vehicle returns to the most recent subject vehicle lane Lns and the cancellation control is complete.

A thirteenth modification of the above-described embodiment stops displaying contents in the standby state when there is a risk target different from other vehicles, specifically, when there is a high-risk target such as an object falling on the road surface causing a high speed relative to the subject vehicle. Therefore, the driver can visually confirm high-risk targets without interference from the contents.

The above-described embodiments hide the fulfillment notification content that overreaches the angle of view is hidden. However, the overreaching fulfillment notification content may be continuously displayed along with the non-superimposition content. An on-operation to activate the LCA function may be input to an input unit other than the turn signal switch. The update of content shapes to follow the road surface shape may be omitted. The display of the response notification content may also be omitted.

According to a fourteenth modification 14 of the above-described embodiment, the display generation unit determines whether the standby notification content overreaches even when the standby notification content is displayed as a superimposition content. When it is determined that the standby notification content does not overreach the angle of view, the display generation unit superimposes the standby notification content indicating an estimated trace on the road surface. When it is determined that the standby notification content overreaches the angle of view, the display generation unit displays the standby notification icon as a non-superimposition content instead of the standby notification content. It may be favorable to transform the standby notification content to be positioned in the angle of view based on the overreach determination. Alternatively, it may be favorable to hide the standby notification content out of the standby notification content and the standby notification icon. In the fourteenth modification, the standby notification content is comparable to a “schedule notification content” that indicates the lane change fulfillment schedule.

According to the second embodiment, the fulfillment notification content and the standby notification content as AR display objects are displayed to superimpose on the road surface in different modes. The fulfillment notification content and the standby notification content may differ from each other in at least one of static elements such as display color, display brightness, display shape, and display size to such an extent that the driver can make a distinction. Alternatively, the fulfillment notification content and the standby notification may differ from each other in at least one of dynamic elements such as the presence or absence of blinking, blink cycles, the presence or absence of animation, and animation motions to such an extent that the driver can make a distinction. When at least one of the static or dynamic elements is different, the fulfillment notification content and the standby notification content are assumed to be placed in different modes.

According to the first embodiment, for example, the standby notification content as a non-superimposition content is displayed in the mode associated with the fulfillment notification content. According to the fifth embodiment, fulfillment notification content CTe is displayed in the mode associated with response notification content CTa. The “associated mode” applies equality or similarity to at least one of the static elements such as display color, display brightness, display shape, and display size to such an extent that the driver can link the elements or recognize the commonality in them. The standby notification content according to the first embodiment, for example, may be associated with the fulfillment notification content because the standby notification content includes image elements such as an extended main body unit and a characteristic main part that are common to the fulfillment notification content.

The above-described embodiments and modifications have described examples of the travel scenes to provide the information. The HCU can provide information by using non-superimposition contents and superimposition contents in travel scenes different from the above. It may be favorable to change the contents as to, for example, the shapes, display positions, display colors, display brightness, the presence or absence of animation as appropriate, or according to the driver's preference, for example.

The HCU according to the above-described embodiments uses the position information detected by DSM at the eyepoint to successively control projection shapes and positions of the virtual image light to be imaged as a superimposition content so that the superimposition content is fittingly superimposed on the superimposition target when viewed from the driver. However, the HCU according to a fifteenth modification of the above-described embodiments does not use the DSM-detected information but uses setup information centered at a predetermined reference eyepoint to control projection shapes and positions of the virtual image light to be imaged as the superimposition content.

The HUD projector according to a sixteenth modification includes an EL (Electro Luminescence) panel instead of the LCD panel and the backlight. Furthermore, the HUD 20 can include a projector using a display instrument such as a plasma display panel, a cathode ray tube, or LED instead of the EL panel.

The HUD according to a seventeenth modification includes a laser module (LSM) and a screen instead of the LCD and the backlight. The LSM includes a laser light source and a MEMS (Micro Electro Mechanical Systems) scanner, for example. The screen uses a micromirror array or a microlens array, for example. Such an HUD draws display images on the screen by scanning the laser beam irradiated from the LSM. The HUD uses a magnifying optical element to project the display images, drawn on the screen, onto the windshield and thereby displays virtual images in the air.

The HUD according to an eighteenth modification includes a DLP (Digital Light Processing, registered trademark) projector. The DLP projector includes a digital mirror device (DMD) provided with many micromirrors as well as a projection light source to project the light toward the DMD. The DLP projector draws display images on the screen under the control of cooperation between the DMD and the projection light source.

The HUD according to a nineteenth modification includes a projector that uses LCOS (Liquid Crystal On Silicon). The HUD according to a twentieth modification uses a holographic optical element as one of the optical systems to display virtual images in the air.

A twenty-first modification of the above-described embodiments integrally configures the HCU and the HUD. That is, the control circuit of the HUD according to the twenty-first modification includes the processing function of the HCU. In the twenty-first modification, the HUD is comparable to a “display control device.” Further, a meter ECU, a navigation ECU, and a display audio ECU may include the processing function of the HCU. According to this modification, a meter, a navigation system, and a display audio instrument are comparable to the “display control devices.”

In the above-described embodiments, the functions provided by the HCU are available as software and hardware to implement the software, software only, hardware only, or multiple combinations thereof. When the functions are provided by an electronic circuit as hardware, the functions can also be provided by a digital circuit or an analog circuit including many logic circuits.

It may be favorable to appropriately change the form of a storage medium that stores a program, for example, capable of implementing the above-described display control method. The storage medium is not limited to the configuration of installation on a circuit board. For example, the storage medium may be provided in the form of a memory card, for example, inserted into a slot, and electrically connected to the control circuit of the HCU. Further, the storage medium may be available as an optical disk or a hard disk drive as a source of copying the program to the HCU.

The HMI system may be mounted on vehicles including not only private vehicles but also hired vehicles, manned taxicabs, ride-sharing vehicles, freight vehicles, and buses. The HMI system and the HCU may be mounted on vehicles dedicated to unattended operations used for Mobility as a Service. The HMI system may be mounted on right-hand-drive vehicles or left-hand-drive vehicles. Display forms of the contents are appropriately optimized according to the steering wheel position of the vehicle, for example.

The control unit and the method thereof described in the present disclosure may be provided by a dedicated computer configuring a processor that is programmed to perform one or more functions embodied by a computer program. Alternatively, the apparatus and the method thereof described in the present disclosure may be provided by a dedicated hardware logic circuit. Moreover, the apparatus and the method thereof described in the present disclosure may be provided by one or more dedicated computers configured by a combination of a processor to execute computer programs and one or more hardware logic circuits. The computer programs as instructions executed by the computer may be stored in a non-transitory tangible computer-readable storage medium.

What is claimed is:

1. A display control device for a vehicle to control a head-up display to display a content in a superimposing manner, the display control device comprising:
an information acquisition unit that acquires lane change information about a lane change of the vehicle from a lane change control unit that controls the lane change of the vehicle; and
a display control unit that displays a schedule notification content, indicating a fulfillment schedule of the lane change made by the lane change control unit, to be superimposed on a road surface in a foreground based on the lane change information,
wherein, when the schedule notification content overreaches an angle of view of the head-up display, the display control unit displays a non-superimposition content that indicates the fulfillment schedule of the lane change independent of a superimposition target.

2. The display control device according to claim 1,
wherein, when the schedule notification content overreaches the angle of view, the display control unit hides the schedule notification content and displays the non-superimposition content.

3. The display control device according to claim 1,
wherein the display control unit displays the schedule notification content shaped in an arrow indicating an estimated trace of the vehicle; and
wherein, when a tip portion of the schedule notification content is positioned within the angle of view, the display control unit continues displaying the schedule notification content.

4. The display control device according to claim 1,
wherein the information acquisition unit acquires on-operation information associated with an on-operation instructing the lane change control unit to fulfill the lane change; and
wherein the display control unit starts displaying the non-superimposition content based on the on-operation information acquired by the information acquisition unit.

5. The display control device according to claim 1,
wherein, when the lane change made by the lane change control unit remains in an execution state, the display control unit displays the schedule notification content to be superimposed in a range ahead of a movement start point to start movement to a destination lane on a road surface of the destination lane according to the lane change.

6. The display control device according to claim 5,
wherein, before the lane change enters the execution state, the display control unit displays a pre-notification content in a mode associated with the schedule notification content to be superimposed on substantially an entire road surface of the destination lane included in the angle of view.

7. The display control device according to claim 1,
wherein the display control unit determines that the schedule notification content overreaches the angle of view when a ratio of an overlap region, overlapping an adjacent lane as a destination of the lane change, to an entire region in the angle of view exceeds a predetermined value.

8. The display control device according to claim 1,
wherein the display control unit determines that the schedule notification content overreaches the angle of view when an outer lane line, which is one of lane lines on both sides of an adjacent lane as a destination of the lane change and being distant from the vehicle, is positioned outside the angle of view.

9. The display control device according to claim 1,
wherein the vehicle has a driver's seat and a passenger seat installed to be placed in a horizontal direction of the vehicle;
wherein the display control unit determines that the schedule notification content does not overreach the angle of view when an adjacent lane near the driver's seat is assumed to be a destination of the lane change; and
wherein the display control unit determines that the schedule notification content overreaches the angle of view when an adjacent lane near the passenger seat is assumed to be a destination of the lane change.

10. A display control device for a vehicle to control a head-up display to display a content in a superimposing manner, the display control device comprising:
an information acquisition unit that acquires lane change information about a lane change of the vehicle from a lane change control unit that controls the lane change of the vehicle; and
a display control unit that displays a schedule notification content using a road surface in a foreground as a superimposition target and a non-superimposition content independent of the superimposition target, as the content indicating a fulfillment schedule of the lane change made by the lane change control unit,
wherein, when the schedule notification content overreaches an angle of view of the head-up display, the display control unit hides the schedule notification content.

11. The display control device according to claim 10,
wherein the display control unit displays the schedule notification content shaped in an arrow indicating an estimated trace of the vehicle; and
wherein, when a tip portion of the schedule notification content is positioned within the angle of view, the display control unit continues displaying the schedule notification content.

12. The display control device according to claim 10,
wherein the information acquisition unit acquires on-operation information associated with an on-operation instructing the lane change control unit to fulfill the lane change; and
wherein the display control unit starts displaying the non-superimposition content based on the on-operation information acquired by the information acquisition unit.

13. The display control device according to claim 10,
wherein, when the lane change made by the lane change control unit remains in an execution state, the display control unit displays the schedule notification content to be superimposed in a range ahead of a movement start point to start movement to a destination lane on a road surface of the destination lane according to the lane change.

14. The display control device according to claim 13,
wherein, before the lane change enters the execution state, the display control unit displays a pre-notification content in a mode associated with the schedule notification content to be superimposed on substantially an entire road surface of the destination lane included in the angle of view.

15. The display control device according to claim 10,
wherein the display control unit determines that the schedule notification content overreaches the angle of view when a ratio of an overlap region, overlapping an adjacent lane as a destination of the lane change, to an entire region in the angle of view exceeds a predetermined value.

16. The display control device according to claim 10,
wherein the display control unit determines that the schedule notification content overreaches the angle of view when an outer lane line, which is one of lane lines on both sides of an adjacent lane as a destination of the lane change and being distant from the vehicle, is positioned outside the angle of view.

17. The display control device according to claim 10,
wherein the vehicle has a driver's seat and a passenger seat installed to be placed in a horizontal direction of the vehicle;
wherein the display control unit determines that the schedule notification content does not overreach the angle of view when an adjacent lane near the driver's seat is assumed to be a destination of the lane change; and
wherein the display control unit determines that the schedule notification content overreaches the angle of view when an adjacent lane near the passenger seat is assumed to be a destination of the lane change.

18. A display control device for a vehicle to control a head-up display to display a content in a superimposing manner, the display control device comprising:
an information acquisition unit that acquires lane change information about a lane change of the vehicle from a lane change control unit that controls the lane change of the vehicle; and
a display control unit that displays an arrow-shaped schedule notification content, having a tip portion indicating an adjacent lane as a destination of the lane change made by the lane change control unit, to be superimposed on a road surface in a foreground based on the lane change information,
wherein, when the tip portion of the schedule notification content in a reference shape overreaches an angle of view of the head-up display, the display control unit transforms the schedule notification content so that the tip portion is positioned within the angle of view.

19. The display control device according to claim 18,
wherein, when the adjacent lane does not overreach the angle of view, the display control unit transforms the schedule notification content so that the tip portion is superimposed on a road surface of the adjacent lane included in the angle of view; and
wherein, when the adjacent lane overreaches the angle of view, the display control unit displays a non-superimposition content that indicates a fulfillment schedule of the lane change independent of a superimposition target, in place of the schedule notification content.

20. The display control device according to claim 18.
wherein the information acquisition unit acquires on-operation information associated with an on-operation instructing the lane change control unit to fulfill the lane change; and
wherein the display control unit starts displaying the non-superimposition content that indicates a fulfillment schedule of the lane change independent of a superimposition target based on the on-operation information acquired by the information acquisition unit.

21. The display control device according to claim 18,
wherein the display control unit determines that the schedule notification content overreaches the angle of view when a ratio of an overlap region, overlapping an adjacent lane as a destination of the lane change, to an entire region in the angle of view exceeds a predetermined value.

22. The display control device according to claim 18,
wherein the display control unit determines that the schedule notification content overreaches the angle of view when an outer lane line, which is one of lane lines on both sides of an adjacent lane as a destination of the lane change and being distant from the vehicle, is positioned outside the angle of view.

23. The display control device according to claim 18,
wherein the vehicle has a driver's seat and a passenger seat installed to be placed in a horizontal direction of the vehicle;
wherein the display control unit determines that the schedule notification content does not overreach the angle of view when an adjacent lane near the driver's seat is assumed to be a destination of the lane change; and
wherein the display control unit determines that the schedule notification content overreaches the angle of view when an adjacent lane near the passenger seat is assumed to be a destination of the lane change.

24. A display control device for a vehicle to control a head-up display to display a content in a superimposing manner, the display control device comprising:
an information acquisition unit that acquires lane change information about a lane change of the vehicle from a lane change control unit that controls the lane change of the vehicle; and
a display control unit that substantially simultaneously displays a schedule notification content using a road surface in a foreground as a superimposition target and a non-superimposition content independent of the superimposition target, as the content indicating a fulfillment schedule of the lane change made by the lane change control unit,
wherein, when an execution of the lane change by the lane change control unit is started, the display control unit displays the schedule notification content and hides the non-superimposition content.

25. A non-transitory computer-readable storage medium which stores program instructions for controlling a head-up display of a vehicle to display a content in a superimposing manner, the program instructions configured to cause one or more processors to:
acquire lane change information about a lane change of the vehicle from a lane change control unit that controls the lane change of the vehicle;
display a schedule notification content, indicating a fulfillment schedule of the lane change made by the lane change control unit, to be superimposed on a road surface in a foreground based on the lane change information; and
display a non-superimposition content that indicates a fulfillment schedule of the lane change independent of a superimposition target, when the schedule notification content overreaches an angle of view of the head-up display.

26. The display control device according to claim 25,
wherein the program instructions are configured to further cause the one or more processors to: acquire on-operation information associated with an on-operation instructing the lane change control unit to fulfill the lane change; and
start displaying the non-superimposition content based on the on-operation information.

27. The display control device according to claim 25,
wherein the program instructions are configured to cause the one or more processors to determine that the schedule notification content overreaches the angle of view when a ratio of an overlap region, overlapping an adjacent lane as a destination of the lane change, to an entire region in the angle of view exceeds a predetermined value.

28. The display control device according to claim 25,
wherein the program instructions are configured to cause the one or more processors to determine that the schedule notification content overreaches the angle of view when an outer lane line, which is one of lane lines on both sides of an adjacent lane as a destination of the lane change and being distant from the vehicle, is positioned outside the angle of view.

29. The display control device according to claim 25,
wherein the vehicle has a driver's seat and a passenger seat installed to be placed in a horizontal direction of the vehicle;
wherein the program instructions are configured to cause the one or more processors to:
determine that the schedule notification content does not overreach the angle of view when an adjacent lane near the driver's seat is assumed to be a destination of the lane change; and
determine that the schedule notification content overreaches the angle of view when an adjacent lane near the passenger seat is assumed to be a destination of the lane change.

30. A non-transitory computer-readable storage medium which stores program instructions for controlling a head-up display of a vehicle to display a content in a superimposing manner, the program instructions configured to cause one or more processors to:
acquire lane change information about a lane change of the vehicle from a lane change control unit that controls the lane change of the vehicle;
display a schedule notification content using a road surface in a foreground as a superimposition target and a non-superimposition content independent of the superimposition target, as the content indicating a fulfillment schedule of the lane change made by the lane change control unit; and
hide the schedule notification content when the schedule notification content overreaches an angle of view of the head-up display.

31. The display control device according to claim 30,
wherein the program instructions are configured to further cause the one or more processors to:
acquire on-operation information associated with an on-operation instructing the lane change control unit to fulfill the lane change; and
start displaying the non-superimposition content based on the on-operation information.

32. The display control device according to claim 30,
wherein the program instructions are configured to cause the one or more processors to determine that the schedule notification content overreaches the angle of view when a ratio of an overlap region, overlapping an adjacent lane as a destination of the lane change, to an entire region in the angle of view exceeds a predetermined value.

33. The display control device according to claim 30,
wherein the program instructions are configured to cause the one or more processors to determine that the schedule notification content overreaches the angle of view when an outer lane line, which is one of lane lines on both sides of an adjacent lane as a destination of the lane change and being distant from the vehicle, is positioned outside the angle of view.

34. The display control device according to claim 30,
wherein the vehicle has a driver's seat and a passenger seat installed to be placed in a horizontal direction of the vehicle;
wherein the program instructions are configured to cause the one or more processors to:
determine that the schedule notification content does not overreach the angle of view when an adjacent lane near the driver's seat is assumed to be a destination of the lane change; and
determine that the schedule notification content overreaches the angle of view when an adjacent lane near the passenger seat is assumed to be a destination of the lane change.

35. A non-transitory computer-readable storage medium which stores program instructions for controlling a head-up display of a vehicle to display a content in a superimposing manner, the program instructions configured to cause one or more processors to:
acquire lane change information about a lane change from a lane change control unit that controls the lane change of the vehicle;
display an arrow-shaped schedule notification content, having a tip portion indicating an adjacent lane as a destination of the lane change made by the lane change control unit, to be superimposed by assuming a road surface in a foreground to be a superimposition target, based on the lane change information; and
transform the schedule notification content so that the tip portion of the schedule notification content in a reference shape is positioned within the angle of view when the tip portion overreaches an angle of view of the head-up display.

36. The display control device according to claim 35,
wherein the program instructions are configured to further cause the one or more processors to:
acquire on-operation information associated with an on-operation instructing the lane change control unit to fulfill the lane change; and
start displaying the non-superimposition content that indicates a fulfillment schedule of the lane change independent of a superimposition target based on the on-operation information.

37. The display control device according to claim 35,
wherein the program instructions are configured to cause the one or more processors to determine that the schedule notification content overreaches the angle of view when a ratio of an overlap region, overlapping an adjacent lane as a destination of the lane change, to an entire region in the angle of view exceeds a predetermined value.

38. The display control device according to claim 35,
wherein the program instructions are configured to cause the one or more processors to determine that the schedule notification content overreaches the angle of view when an outer lane line, which is one of lane lines on both sides of an adjacent lane as a destination of the lane change and being distant from the vehicle, is positioned outside the angle of view.

39. The display control device according to claim 35,
wherein the vehicle has a driver's seat and a passenger seat installed to be placed in a horizontal direction of the vehicle;
wherein the program instructions are configured to further cause the one or more processors to:
determine that the schedule notification content does not overreach the angle of view when an adjacent lane near the driver's seat is assumed to be a destination of the lane change; and
determine that the schedule notification content overreaches the angle of view when an adjacent lane near the passenger seat is assumed to be a destination of the lane change.

40. A non-transitory computer-readable storage medium which stores program instructions for controlling a head-up display of a vehicle to display a content in a superimposing manner, the program instructions configured to cause one or more processors to:
acquire lane change information about a lane change of the vehicle from a lane change control unit that controls the lane change of the vehicle;
substantially simultaneously display a schedule notification content using a road surface in a foreground as a superimposition target and a non-superimposition content independent of the superimposition target, as the content indicating a fulfillment schedule of the lane change made by the lane change control unit; and
display the schedule notification content and hide the non-superimposition content, when an execution of the lane change by the lane change control unit is started.
